(19) United States
(12) Patent Application Publication
(10) Pub. No.: US 2026/0316864 A1
(43) Pub. Date: Oct. 15, 2026

(54) VEHICLE HAVING DEPLOYABLE ACTUATED STABILIZING ARM AND/OR STEERING SYSTEM ASSEMBLIES

(71) Applicant: Stark Technologies Inc., Clermont, FL (US)

(72) Inventors: Alec Denis Dian, Ocoee, FL (US); Karina Alejandra Nunes Joaquim, Ocoee, FL (US)

(21) Appl. No.: 19/643,741

(22) Filed: Apr. 9, 2026

Related U.S. Application Data
(60) Provisional application No. 63/786,824, filed on Apr. 10, 2025.

(51) Int. Cl. B62H 1/12

(52) U.S. Cl. CPC B62H 1/12

(57) ABSTRACT

A vehicle system including a deployable stabilizing assembly and a selectively engageable steering system is disclosed. The stabilizing assembly includes stabilizing arm arrangements disposed on opposite lateral sides of a vehicle. The arrangements have proximal and distal arm portions and ground-engaging members. Actuators move the arm arrangements between retracted and deployed states to contact a ground surface and stabilize the vehicle based on sensed conditions, such as tilt or ground incline. A control system receives orientation data and selectively deploys one or both arm arrangements to prevent tipping and maintain an upright configuration. The steering system includes an actuator and an electromagnetic clutch configured to selectively couple the actuator to a steering linkage. When disengaged, the vehicle may be steered manually; when engaged, the actuator provides motor-driven steering for remote or autonomous operation.

### CROSS-REFERENCE TO RELATED APPLICATION

This application claims the benefit of U.S. Provisional Patent Application 63/786,824, filed Apr. 10, 2025, which is hereby incorporated by reference in its entirety.

### TECHNICAL FIELD

The present disclosure generally relates to stabilizing and/or steering system assemblies for vehicles, such as scooters, bicycles, or other single-track vehicles.

### BACKGROUND

Unmanned and autonomous vehicles are increasingly deployed in a wide range of applications, including delivery systems, inspection platforms, and personal mobility solutions. These vehicles may operate with or without a rider and may rely on onboard sensing and control systems to navigate and perform tasks. In various scenarios, autonomous operation may include remote control, partially autonomous modes, or fully self-directed operation. As such systems continue to develop, there is a need for vehicle platforms that can maintain stability during operation, including when stationary, during low-speed maneuvers, or when transitioning between operating modes.

Certain vehicle configurations, including single-track or narrow-profile vehicles such as scooters, bicycles, and similar platforms, are inherently laterally unstable when not actively balanced. Such vehicles may tip or fall over when a rider is not present, when operating at low speeds, or when subject to uneven terrain or external disturbances. Conventional approaches, such as fixed training wheels or kickstands, may provide limited support but often lack the ability to dynamically respond to changing conditions, provide stabilization during active operation, or provide stabilization without manual interaction. Accordingly, there is a need for improved systems and methods for stabilizing vehicles, particularly autonomous-capable vehicles.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The implementations are illustrated by way of example and not by way of limitation in the figures of the accompanying drawings. It should be noted that references to “an” or “one” implementation in this disclosure are not necessarily to the same implementation, and they mean at least one. In the drawings, in accordance with one or more implementations:

FIG. 1 illustrates a networked vehicle system;

FIGS. 2A-B illustrate a vehicle having a stabilizing arm assembly;

FIGS. 3A-C illustrate a vehicle-stabilizing arm assembly;

FIGS. 4A-C illustrate a scooter having a stabilizing arm assembly and a steering system assembly;

FIGS. 5A-C illustrate stabilizing arm assembly deployment and/or retraction operations;

FIG. 6 illustrates a control architecture for a stabilizing arm assembly; and

FIG. 7 illustrates a block diagram of a computing system.

### DETAILED DESCRIPTION

### 1. Summary

One or more implementations relate to an autonomous and/or networked unmanned vehicle system that includes a vehicle-stabilizing arm assembly. For example, one or more implementations relate to an unmanned scooter and/or on-demand scooter platform in which one or more scooters are equipped with a selectively deployable actuated stabilizing assembly. In some implementations, the autonomous and/or networked unmanned vehicle system includes a fleet of scooters that are equipped with self-stabilizing arm assemblies.

One or more implementations relate to stability and/or support assemblies for one or more vehicles. More particularly, some embodiments relate to a deployable, actuated, vehicle-stabilizing arm assembly for a scooter or other single-track vehicle. The stabilizing assembly is mounted on the vehicle to facilitate stability and/or support of the vehicle. In one or more implementations, a control unit interfaces with actuators of the stabilizing assembly, an inertial measurement unit (IMU) and/or other sensors and controls the deployment of the stabilizing assembly based on orientation of the vehicle and/or based on conditions of the environment around the vehicle. The stabilizing assembly includes two stabilizing arms. The stabilizing arms use actuators and planetary gearboxes to provide torque strength to facilitate stability.

In one or more implementations, the stabilizing assembly is automatically deployed based on determining that the vehicle is idle. In some implementations, a stabilizing assembly on a scooter is automatically deployed based on determining that a scooter is leaning or beginning to lean. In other implementations, the stabilizing assembly is deployed responsive to manual deployment. In some implementations, the scooter automatically travels a small distance to result in wheels of the stabilizing assembly being aligned. For example, a small motion forward aligns the wheels laterally.

One or more implementations relate to a self-stabilizing vehicle or vehicle system. One or more implementations of the self-stabilizing vehicle system include one or more of: a vehicle body; a mobility arrangement configured to support movement of the vehicle body; a stabilizing assembly coupled to the vehicle body, the stabilizing assembly comprising: (i) a first stabilizing arm arrangement disposed on a first lateral side of the vehicle body and (ii) a second stabilizing arm arrangement disposed on a second lateral side of the vehicle body opposite the first lateral side, wherein: the first stabilizing arm arrangement includes (i) a first proximal arm portion and (ii) a first distal arm portion movable relative to the first proximal arm portion; and the second stabilizing arm arrangement includes (i) a second proximal arm portion and (ii) a second distal arm portion movable relative to the second proximal arm portion; a first actuator set comprising one or more actuators operatively coupled to the first stabilizing arm arrangement and configured to move the first stabilizing arm arrangement between a first retracted state and a first deployed state; a second actuator set comprising one or more actuators operatively coupled to the second stabilizing arm arrangement and configured to move the second stabilizing arm arrangement between a second retracted state and a second deployed state; and a control system operatively coupled to the first actuator set and the second actuator set, the control system being configured to: move the first stabilizing arm arrangement between the first retracted state and the first deployed state; move the second stabilizing arm arrangement between the second retracted state and the second deployed state; and control the first stabilizing arm arrangement in the first deployed state and the second stabilizing arm arrangement in the second deployed state such that at least a portion of at least one of the first stabilizing arm arrangement or the second stabilizing arm arrangement engages a ground surface.

One or more implementations relate to one or more methods for stabilizing a vehicle using a stabilizing assembly. The one or more methods include one or more of: detecting a deployment condition; responsive to detecting the deployment condition, moving, with one or more actuators of the stabilizing assembly, at least one of a first stabilizing arm arrangement of the stabilizing assembly or a second stabilizing arm arrangement of the stabilizing assembly from a retracted state toward a deployed state; and controlling, with the one or more actuators, at least one of the first stabilizing arm arrangement or the second stabilizing arm arrangement in the deployed state to position at least one of a first ground-engaging member of the first stabilizing arm arrangement or a second ground-engaging member of the second stabilizing arm arrangement in contact with a ground surface to resist tipping of the vehicle, wherein: the first stabilizing arm arrangement is disposed on a first lateral side of the vehicle; the second stabilizing arm arrangement is disposed on a second lateral side of the vehicle opposite the first lateral side; the first stabilizing arm arrangement includes (i) a first proximal arm portion and (ii) a first distal arm portion movable relative to the first proximal arm portion; the second stabilizing arm arrangement includes (i) a second proximal arm portion and (ii) a second distal arm portion movable relative to the second proximal arm portion; the first ground-engaging member is coupled to a first distal end region of the first distal arm portion; and the second ground-engaging member is coupled to a second distal end region of the second distal arm portion.

One or more implementations include one or more non-transitory computer-readable media including instructions that cause performance of one or more of the methods when executed by one or more hardware processors. One or more implementations include a system having one or more hardware processors; one or more vehicles; one or more stabilizing assemblies; and one or more non-transitory computer readable media configured to execute instructions stored on the one or more non-transitory computer readable media which, when executed by the one or more hardware processors, cause the system to perform one or more of the methods.

The Figures (FIGS.) and the following description describe certain embodiments by way of illustration only. One skilled in the art will readily recognize from the following description that alternative implementations of the structures and methods illustrated herein may be employed without departing from the principles described herein. Reference will now be made to several implementations, examples of which are illustrated in the accompanying figures. Wherever practicable, similar or like reference numbers may be used in the figures and may indicate similar or like functionality.

### 2. Networked Vehicle System

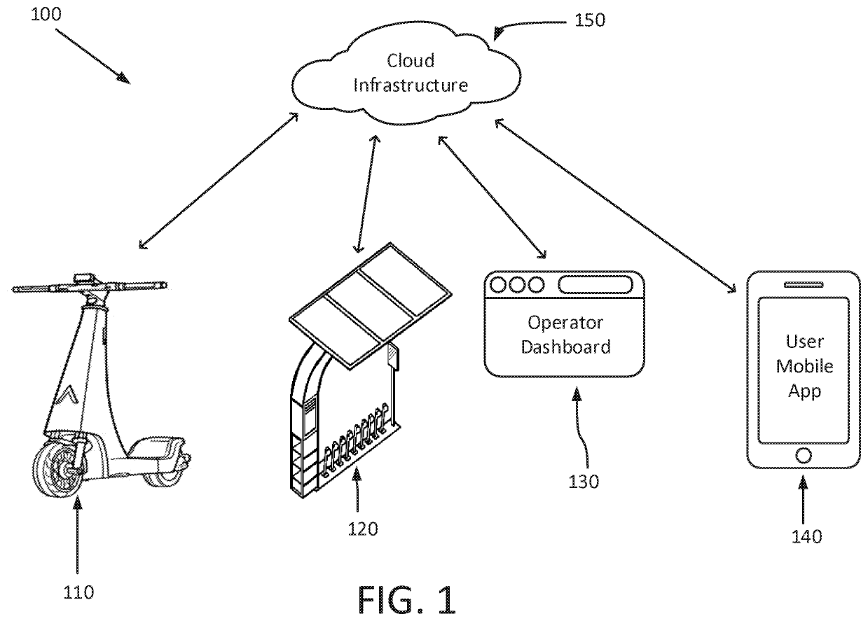

FIG. 1 illustrates a networked vehicle system. In particular, FIG. 1 illustrates an exemplary networked vehicle system for providing an on-demand electric scooter and delivery service. In FIG. 1, the system 100 includes an electric scooter 110, a charging station 120, an operator dashboard 130, a user mobile application (app) 140, and a cloud infrastructure 150. One or more implementations include multiple scooters 110, multiple charging stations 120, multiple operator dashboards 130, and/or multiple mobile apps 140 that are interconnected via the cloud infrastructure 150. In various embodiments, one or more of these components may be substituted or augmented with functionally equivalent modules. Together, these elements facilitate remote teleoperation, user-requested rides, and efficient fleet management of electric scooters 110, including automated relocation, goods delivery, and on-demand repositioning.

In one or more implementations, the electric scooter 110 is built to accommodate manual rider input and/or remote teleoperation. In some embodiments, the scooter may integrate certain self-driving functionalities or advanced sensor arrays, while in others it may rely primarily on real-time operator oversight.

In various implementations, example features of the electric scooter 110 may include one or more of the following:

In some implementations, the scooter 110 includes a self-balancing stabilizer mechanism that incorporates a stabilizer (e.g., one or more deployable arms) to detect and correct tipping events in conjunction with IMUs.

In some implementations, the scooter 110 includes a steering and clutch mechanism that includes a steering actuator coupled with a clutch to allow seamless switching between manual rider control and teleoperation. In some implementations, the steering and clutch mechanism detects steering inputs and optionally activates turning signals automatically during cornering.

In some implementations, the scooter 110 includes emergency braking with light detection and ranging (LiDAR) that includes forward-facing LiDAR sensor (or radar, ultrasonic array, etc.) that monitors the scooter's path for sudden obstacles or hazards. If collision risk is detected, the scooter can autonomously apply braking via the Motor Control Unit (MCU).

In some implementations, the scooter 110 includes custom bodywork and/or a shell design, such as custom plastic or a composite shell that encloses and protects internal components (wires, sensors, electronics). This shell can also reduce drag, effectively increasing range through enhanced aerodynamic performance.

In some implementations, the scooter 110 includes pedestrian awareness audio. For example, the scooter may be equipped with one or more speakers connected to an Internet of Things (IoT) or electronic control unit (ECU) module. When driven (either physically or remotely), the scooter may play a subtle audio to alert pedestrians of its presence, mitigating potential collisions or surprise encounters.

In some implementations, the scooter 110 includes autonomous operation: For example, although scooters may be operated through teleoperation in some implementations, in some embodiments the scooter may be equipped with advanced autonomy software for self-driving. Such a self-driving system may integrate computer vision, sensor fusion, path planning and control, and/or connectivity and cargo options. For example, computer vision leverages onboard cameras or LiDAR to detect obstacles, lane markings, and signage. Sensor fusion merges IMU, global positioning service (GPS), LiDAR, radar, or other sensor data to plan paths and avoid collisions without active remote operator input. Autonomous operation is not limited to a single hardware configuration or sensor suite; there are multiple potential architectures for achieving varying levels of autonomy. Some implementations use automated algorithms stored in non-transitory memory and executed by the IoT or a dedicated processor to enable route selection, steering, braking, and/or throttle control. One or more implementations of the scooter 110 contain a modem for communication with the cloud infrastructure 150 and/or direct connection with the operator dashboard 130. In some implementations, the scooter 110 autonomously accepts cargo boxes or food items for deliveries and so may be used as a courier or food delivery service.

In one or more implementations, the charging station 120 serves as a docking point to store and/or recharge the electric scooter 110. Although described here in a particular form, it will be recognized that the design of the charging station 120 may vary depending on location, environmental constraints, or specific operational goals. In some embodiments, multiple smaller charging stations or a centralized charging hub may be employed. By maintaining scooters 110 at sufficient charge and providing enhanced security, the charging station helps scooters 110 to remain accessible and well-maintained for rides or deliveries.

One or more implementations of the charging station 120 may include one or more of the following features:

In some implementations, the charging station 120 includes power and solar Integration. For example, the charging station 120 may draw power from a conventional grid source or rely on solar panels coupled with an internal battery for off-grid operation. The charging station 120 may automatically schedule charging sessions based on information from the cloud infrastructure 150 to maintain optimal battery levels across a fleet of scooters 110. In addition to solar integration, the charging station 120 may feature a swiveling top section (manually or motorized) along with sensors to optimize solar panel angle for maximum sun exposure.

In some implementations, the charging station 120 includes docking and/or locking. For example, the charging station 120 may feature custom charging pads or connectors, optionally equipped with radio frequency identification (RFID) or near-field communication (NFC) to authenticate scooters before initiating charging. In some implementations, the charging station uses electromechanical locks or actuators to physically secure scooters, preventing unauthorized removal or tampering.

In one or more implementations, the charging station 120 includes an onboard computer with one or more cameras to monitor docked scooters for damage or vandalism. In some implementations, an onboard computer communicates charge progress, battery status, and/or station availability to the cloud infrastructure 150 in real time.

In some implementations, the charging station 120 may include a weatherproof display presenting a service tutorial, local maps, or route planning information. In some implementations, the charging station 120 provides Wi-Fi hotspots for users or scooters, automated lighting, locked compartments for helmet storage (with optional ultraviolet light sterilization), and/or sanitizing wipe dispensers.

In some implementations, the charging station 120 includes a modular design. For example, in locations lacking sufficient sunlight, solar panels may be replaced by protective roofing while connecting the station to the local power grid. In some implementations, a frame of a charging station 120 can be scaled to adjust capacity (e.g., by adding more docking spaces) based on changing demand.

In one or more implementations, the operator dashboard 130 presents a specialized interface for remote fleet oversight, teleoperation, and administrative control. In some embodiments, the dashboard 130 may also serve as a limited-access platform for partner businesses or municipalities, facilitating collaborative functionalities. Various implementations of the dashboard 130 may include a dedicated web application, a stand-alone desktop application or mobile interface. The operator dashboard 130 may include one or more of: teleoperation tools, alert systems, restricted access modes, and/or potential order management. In one or more implementations, the dashboard 130 includes one or more of the following features:

In one or more implementations, the operator dashboard 130 includes authentication, role management, and/or limited-access modes: For example, the dashboard 130 displays a secure login for operators, admins, or external partners (e.g., businesses, restaurants, city officials), with tailored access privileges. This allows administrators to create, revoke, or modify operator accounts, limiting dashboard functionality according to defined roles or regions. In a limited-access configuration, the dashboard may function primarily as a remote view or compliance dashboard, allowing designated partners (e.g., local governments, corporate clients) to see scooter locations on a map, stream real-time camera feeds, and monitor system usage without necessarily granting full teleoperation privileges.

In one or more implementations, the operator dashboard 130 includes a map view and/or analytics. For example, the dashboard 130 renders real-time maps with scooter locations, battery levels, and relevant operating zones (low-speed, no-ride areas). In some implementations, the dashboard 130 provides ride statistics, user analytics, demand heat maps, and comprehensive ride histories for data-driven decision-making.

In one or more implementations, the operator dashboard 130 includes teleoperation controls. For example, the dashboard 130 permits operators to drive scooters remotely using a keyboard or a gamepad (e.g., controller), receiving live video feeds directly via a secure channel. In some implementations, the dashboard 130 displays critical telemetry (signal quality, battery voltage, speed, steering angle, etc.), with immediate alerts for safety-critical events.

In one or more implementations, the operator dashboard 130 includes ride, request, and/or task management functionality. For example, the dashboard 130 shows active rides, pending requests, and completed remote tasks in a queue; tasks may include relocating scooters to charging stations or delivering scooters to users. In some implementations, the dashboard 130 offers administrative tools for adjusting pricing, managing invoices, payment methods, promotions, and refunds.

In one or more implementations, the operator dashboard 130 includes system alerts and oversight functionality. For example, the dashboard 130 provides real-time alerts when a user or partner requests a scooter delivery to a specific location, or when a scooter must be moved for any reason (maintenance, no-parking zone, etc.). In some implementations, the dashboard 130 issues notifications for scooters needing maintenance or for anomalous situations (e.g., scooters forcibly moved) and/or allows operators to manage common tasks (e.g., unlock compartments, activate lights, change settings, or the like) across multiple scooters.

In one or more implementations, the operator dashboard 130 provides partner business and/or restaurant integrations. In certain embodiments, the dashboard 130 can integrate an order-management interface for businesses and restaurants. For example, the dashboard 130 notifies merchants when a user places an order through the user mobile app 140 and dispatches a scooter 110 for delivery, which gets added to the requests queue. In some implementations, the dashboard 130 allows the business to track a live location of the scooter 110, optionally including camera feeds, to facilitate timely handoff of goods.

The user mobile app 140 is an interface for end-users to request, manage, and complete scooter rides. In some embodiments, the mobile app 140 may also facilitate the order and delivery of goods, highlight battery constraints, and provide advanced trip planning. One or more implementations of the mobile app 140 include one or more of the following functionalities:

In one or more implementations, the user mobile app 140 includes user registration and account management functionality. For example, the mobile app 140 enables new users to sign up, manage profiles, and select payment methods and/or provides tutorials for safe scooter operation.

In one or more implementations, the user mobile app 140 includes scooter discovery and/or ride request functionality. For example, the mobile app 140 shows nearby scooters with relevant information (e.g., price, battery level, speed-limited areas, restricted zones, and/or the like) on a map. In some implementations, the mobile app 140 lets users request scooters for direct delivery to a specified location by searching for addresses or tapping on the map to indicate precisely where they want the scooter delivered and/or allows users to specify their final destination. The system then calculates approximate cost, determines if the battery range of the scooter 110 is sufficient, and/or provides an estimated time of arrival to the destination.

In one or more implementations, the user mobile app 140 provides real-time updates and/or delivery notifications. For example, the mobile app 140 notifies users of the scooter's estimated time of arrival (ETA) to their requested location, provides a way to track the scooter's movement if remotely driven, and/or sends a push notification when the requested scooter arrives at the chosen location.

In one or more implementations, the user mobile app 140 includes reservation window and unlocking functionality. For example, the mobile app 140 displays how long the user has to unlock a scooter 110 before the reservation for that scooter 110 expires (to reduce or prevent indefinite holds on scooters) and/or supports scanning a quick-response (QR) code to confirm a user's presence or intercept the scooter along its route.

In one or more implementations, the user mobile app 140 includes a ride execution panel and/or an instrument panel. For example, the mobile app 140, once unlocked, transitions into an instrument panel, showing real-time ride metrics (time, distance traveled, battery remaining) and/or turn-by-turn navigation based on the previously entered destination, and/or allows changing riding modes, controlling lights, or adding additional scooters 110 to the ride (e.g., for traveling with a companion).

In one or more implementations, the user mobile app 140 includes a ride completion and/or payment interface. For example, the mobile app 140 facilitates ending rides, locking scooters, displays itemized summaries (e.g., distance, time, cost), retains receipts and/or ride histories in the user's account, enables users to report technical issues, and/or plays audible alerts to help locate a scooter 110.

In one or more implementations, the user mobile app 140 includes functionality related to delivery of food and/or other goods. In some implementations, the app 140 may allow users to order the delivery of food and other goods from partner merchants to a specified location. Users can track the location of the scooter 110 assigned to delivering their order along with an estimated time of arrival to their selected location. Once the order is delivered to the user, the app 140 sends a push notification, and the user gets access to unlocking a cargo box of the scooter 110 through the app.

In one or more embodiments, the cloud infrastructure 150 (also referred to herein as the “backend”) is responsible for coordinating and managing communication, data, and business logic among other system components. This description is illustrative, and alternative cloud or server configurations may be employed. In one or more implementations, the cloud infrastructure 150 includes one or more of the following functionalities:

In one or more embodiments, the cloud infrastructure 150 includes networking, security, and/or application programming interfaces (APIs). The cloud infrastructure 150 coordinates communication between the electric scooter 110, the charging station 120, the operator dashboard 130, and/or the mobile app 140 using a secured networking architecture. In one or more implementations, the cloud infrastructure 150 manages security, encryption protocols, and user authentication sessions and/or exposes APIs for the dashboard, mobile app, and scooters to interact with core services. In some embodiments, these features may run on separate microservices, whereas in others they are consolidated into a single backend.

In one or more embodiments, the cloud infrastructure 150 includes user and/or ride management functionality. For example, the cloud infrastructure 150 assists with user creation, authentication, profile data, and session tracking for both the dashboard 130 and mobile app 140. In some implementations, the cloud infrastructure 150 controls the logic for requesting and assigning a nearest scooter 110 to a user, verifying user eligibility, unlocking scooters, and/or ending rides.

In one or more embodiments, the cloud infrastructure 150 includes ride integrity functionality. For example, the cloud infrastructure 150 maintains ride integrity by calculating ride time, distance driven, cost, and/or by preventing unauthorized abandonment in restricted zones.

In one or more embodiments, the cloud infrastructure 150 provides teleoperation initialization functionality. In some implementations, the cloud infrastructure 150 acts as a handler to establish a secure, direct communication channel between the operator dashboard 130 and an electric scooter 110 for teleoperation. While real-time audio/video streaming and control may pass directly between operator dashboard 130 and scooter 110, the cloud infrastructure 150 can still initiate, monitor, relay, or terminate these sessions to facilitate overall system stability.

In one or more embodiments, the cloud infrastructure 150 includes one or more databases and/or performs data handling. For example, the cloud infrastructure 150 maintains a database of the status (battery, location, and/or the like) of scooters 110, user information, ride histories, scooter requests, client orders, and/or the like. In some implementations, the cloud infrastructure 150 aggregates telemetry and usage patterns for future system improvements, such as ride analytics, operator intervention logs, and maintenance scheduling.

In one or more embodiments, the cloud infrastructure 150 provides payment processing and/or notifications. For example, the cloud infrastructure 150 integrates with one or more payment providers to process transactions, subscriptions, refunds, or promotions and/or issues email or push notifications for ride updates, receipts, system alerts, and other relevant events.

In one or more embodiments, the cloud infrastructure 150 incorporates load balancing and is scalable. For example, the cloud infrastructure 150 uses distributed or cloud-based architecture to handle high volumes of user requests and teleoperation commands and/or dynamically allocates resources to maintain real-time responsiveness, particularly during surges in user demand.

In one or more embodiments, the cloud infrastructure 150 includes fleet status monitoring and automatic task functionality. For example, the cloud infrastructure 150 may dynamically update the status of scooters 110 in the operator dashboard 130 and the user mobile app 140 based on sensor data (e.g., battery level, location). In some implementations, the cloud infrastructure 150 predicts demand by zone using historical ride data, active usage levels, weather, and traffic patterns and uses this information to trigger automated tasks such as relocating low-battery scooters or moving idle scooters to higher-demand areas. In some implementations, the cloud infrastructure 150 issues commands to lock or unlock scooters 110, honk, change operational modes, or change scooter settings, as needed.

As illustrated in FIG. 1, these components work together to form a cohesive, on-demand micro-mobility and delivery ecosystem. For example, one or more implementations provide on-demand access whereby a user requests a ride through the user mobile app 140 and the cloud infrastructure 150 verifies availability, calculates costs, and initiates scooter deployment. If needed, the operator dashboard 130 provides teleoperation to deliver the electric scooter 110 to the user.

One or more implementations provide real-time teleoperation and safety whereby operators connect to stream cameras and control steering, throttle, and brakes, and a stabilizer and/or LiDAR sensor of a scooter 110 automatically maintain stability and apply emergency braking if collision risk is detected.

One or more implementations provide automatic repositioning and task management whereby the cloud infrastructure 150 identifies scooters 110 with low battery or in low-demand areas, prompting teleoperation or automated tasks to reposition them. The operator dashboard 130 or scheduling logic can direct scooters 110 to the charging station 120 or other strategic points.

One or more implementations provide cargo delivery whereby, with an optional cargo box, a scooter 110 is used to deliver food or goods. In some implementations, teleoperation, real-time tracking, and electronically-locked cargo boxes help goods move efficiently, conveniently, and securely.

One or more implementations provide seamless charging and fleet maintenance whereby, when an electric scooter 110 arrives at a charging station 120, the scooter 110 automatically docks and recharges. In some implementations, the station 120 relays charge status to the cloud infrastructure 150 to update availability of the scooter 110 once the battery is restored.

Single track vehicle configurations, which include scooters, bicycles, and other narrow-profile vehicles, are inherently laterally unstable when not actively balanced. Such vehicles may tip or fall over when a rider is not present, when operating at low speeds, or when subjected to uneven terrain or external disturbances. Conventional approaches, such as fixed training wheels or kickstands, may provide only limited support and often do not dynamically respond to changing operating conditions. While example stabilization systems are described in relation to scooters 110, aspects of such stabilization system also apply to other vehicles.

One or more implementations include a stabilization system that prevents damage and undesirable placement (e.g., laying on the ground) of scooters 110 by selectively deploying stabilizing structures in response to sensed vehicle conditions. One or more implementations use the stabilization system to reduce tip-over events, improve upright stability during stationary and low-speed operation, facilitate more reliable unmanned or autonomous use, and/or help a vehicle to maintain a narrower profile when stabilization is not needed. These improvements can enhance safety, can reduce damage to vehicle components and sidewalks, and can improve the operational reliability of vehicle control systems. In some implementations, the stability system may automatically deploy stabilizing arms when a scooter 110 is parked or docked at a charging station 120 subsequent to either manual or autonomous driving.

The aforementioned techniques further improve the functioning of the networked vehicle system by reducing deployment of scooters with insufficient battery power, by maintaining user profiles to reduce bandwidth use and data entry, and/or by using cloud resources to manage processor load and/or memory use by a scooter.

### 3. Stabilizing Arm Assembly System

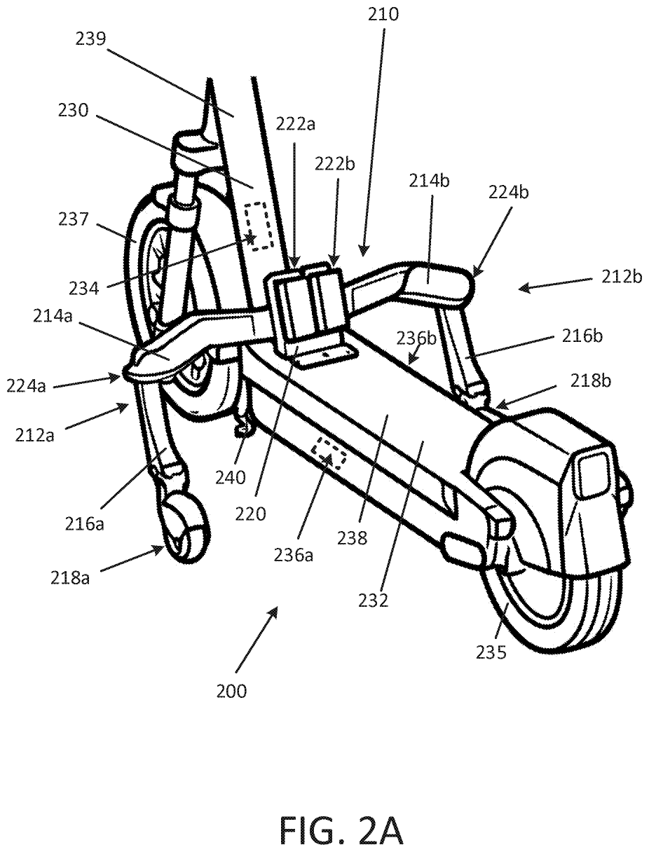

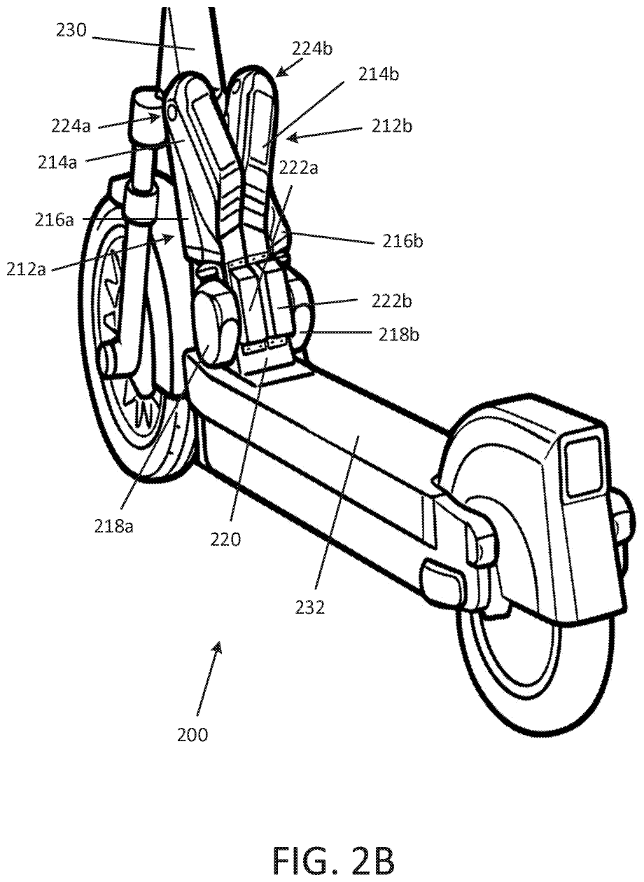

FIGS. 2A-B illustrate a stabilizing arm assembly system, in accordance with one or more implementations. As illustrated in FIGS. 2A-B, the stabilizing arm assembly system 200 includes a stabilizing arm assembly 210 coupled to an electric scooter 230. The illustrated components represent functional components of the stabilizing arm assembly system 200 and are not intended to require a particular physical architecture. In one or more implementations, components may be combined, subdivided, and/or redistributed. Functionality described as being performed by a particular component may be performed by any other component or distributed across multiple components. Although an electric scooter 230 is illustrated in the example of FIGS. 2A-B, aspects of the stabilizing arm assembly system 200 are also applicable to various other single track vehicles, including other types of scooters, bicycles, and other narrow-profile vehicles.

FIG. 2A shows the stabilizing arm assembly 210 in a deployed state. As shown, the stabilizing arm assembly 210 includes a left stabilizing arm 212a disposed on a left lateral side of the scooter 230, a right stabilizing arm 212b disposed on a right lateral side of the scooter 230, a mount 220, a left proximal actuator 222a, a right proximal actuator 222b, a left distal actuator 224a, and a right distal actuator 224b.

As shown, the left stabilizing arm 212a includes a proximal stabilizing arm portion 214a movable relative to the mount 220, a distal stabilizing arm portion 216a movable relative to the proximal stabilizing arm portion 214a, and the left ground-engaging member 218a. In this example, a proximal end of the proximal arm portion 214a is mechanically coupled to the left proximal actuator 222a to facilitate movement of the proximal arm portion 214a between a fully retracted state and a fully deployed state. A distal end of the proximal arm portion 214a and a proximal end of the distal arm portion 216a are coupled to the left distal actuator 224a to facilitate movement between the fully retracted state and the fully deployed state. In one or more implementations, when the left stabilizing arm 212a is in a deployed or fully deployed state, the left ground-engaging member 218a engages the ground and provides stability to the scooter 230.

Likewise, the right stabilizing arm 212b includes a proximal stabilizing arm portion 214b movable relative to the mount 220, a distal stabilizing arm portion 216b movable relative to the proximal stabilizing arm portion 214b, and a right ground-engaging member 218b. In this example, a proximal end of the proximal arm portion 214b is mechanically coupled to the right proximal actuator 222b to facilitate movement of the proximal arm portion 214b between a fully retracted state and a fully deployed state. A distal end of the proximal arm portion 214b and a proximal end of the distal arm portion 216b are coupled to the right distal actuator 224b to facilitate movement between the fully retracted state and the fully deployed state. In one or more implementations, when the right stabilizing arm 212b is in a deployed or fully deployed state, the right ground-engaging member 218b engages the ground and provides stability to the scooter 230.

As shown, the scooter 230 includes a scooter body 232, a control unit 234, a left proximity sensor 236a, a right proximity sensor 236b, a rear wheel 235, and a front wheel 237.

In the example, the body 232 includes a footboard 238 that extends between the rear wheel 235 and the front wheel 237 and a vertical portion 239 that extends upward from a location near a front end of the footboard 238.

In one or more implementations, the control unit 234 includes an IMU, one or more processors, data storage, and/or a control system. In various implementations, the control unit 234 may interface with a charging station, an operator dashboard, a mobile app, and/or cloud infrastructure and/or may be used to drive one or more actuators of the stabilizing arm assembly 210, either in response to manual activation of the stabilizing arm assembly (e.g., via interaction with the scooter 230, the operator dashboard, or the mobile app) or automatically in response to a deployment condition being met (e.g., the scooter 230 being parked, tilted, or docked at a charging station). Although the control unit 234 is illustrated as being integrated into a vertical portion 239 of the body 232 that extends from a footboard 238 to a handle, the control unit 234 may be otherwise located in some implementations. For example, the control unit 234 may be integrated into the footboard 238 of the body 232, may be mounted onto the body 232, or may be integrated into the stabilizing arm assembly 210.

The proximity sensors 236a, 236b detect presence of objects in the environment around the scooter 230. In some implementations, the stabilizing arm assembly 210 will not deploy a stabilizing arm 212a, 212b or will only partially deploy a stabilizing arm 212a, 212b on a lateral side of the scooter 230 if an object (e.g., a wall) is present along the same lateral. The proximity sensors 236a, 236b interface with the control unit 234 and provide proximity data to the control unit 234. In some implementations, the control unit 234 refrains from driving the left actuators 222a, 224a, or the right actuators 222b, 224b, responsive to an object being present, respectively, on the left or right of the scooter 230. Although the proximity sensors 236a, 236b are illustrated as being installed on central portions of side portions of the footboard 238, one or more proximity sensors 236a, 236b may be otherwise located in some implementations. For example, one or more proximity sensors may be located near the front or back of the footboard 238, along the vertical portion 239, along an axle of the scooter, or mounted onto another portion of the body 232.

In some implementations, the scooter 230 may further include a kickstand 240, separate from the stabilizing arm arrangement 210, that may be manually deployed to prevent the scooter 230 from fully tipping over. For example, a user may deploy the kickstand 240 by extending or rotating the kickstand 240 so that a portion of the kickstand 240 engages the ground when the scooter 230 is partially tipped. This may be particularly useful when the stabilizing arm assembly 210 is set to off or does not have electrical power.

FIG. 2B shows the stabilizing arm assembly 210 in a retracted state. As shown, the left stabilizing arm 212a and the right stabilizing arm 212b are positioned adjacent to the scooter body 232 such that the stabilizing arm assembly 210 is contained within a lateral width of the scooter 230. In this example, the proximal stabilizing arm portions 214a, 214b and the distal stabilizing arm portions 216a, 216b are folded toward the body 232, and the left ground-engaging member 218a and the right ground-engaging member 218b are positioned inward relative to the deployed configuration.

In one or more implementations, the left proximal actuator 222a and the right proximal actuator 222b move the proximal stabilizing arm portions 214a, 214b toward the body 232, and the left distal actuator 224a and the right distal actuator 224b move the distal stabilizing arm portions 216a, 216b relative to the proximal stabilizing arm portions 214a, 214b to achieve the retracted configuration. For example, the proximal stabilizing arm portions 214a, 214b rotate toward the scooter body 232 while the distal stabilizing arm portions 216a, 216b are repositioned to align with the proximal stabilizing arm portions 214a, 214b.

In the example, the left ground-engaging member 218a and the right ground-engaging member 218b are oriented such that the left ground-engaging member 218a and the right ground-engaging member 218b fit within a profile of the scooter body 232 when the stabilizing arm assembly 210 is in the retracted state. In one or more implementations, the positioning of the stabilizing arm assembly 210 in the retracted state results in the stabilizing arm assembly 210 not extending beyond side surfaces of the scooter body 232.

### 4. Stabilizing Arm Assembly

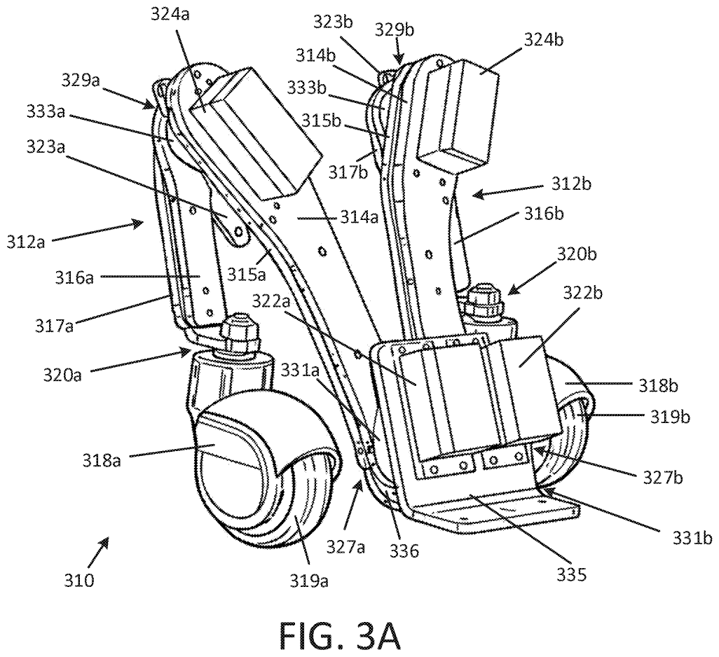

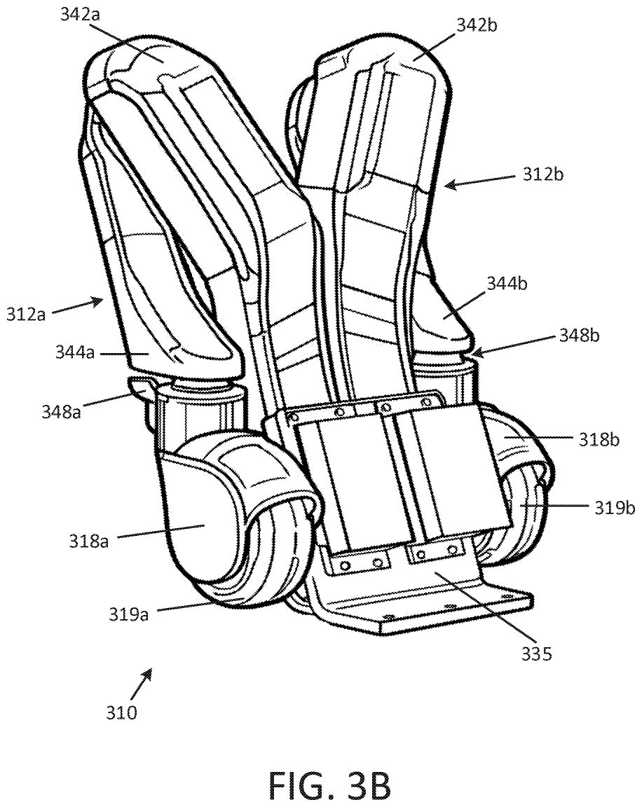

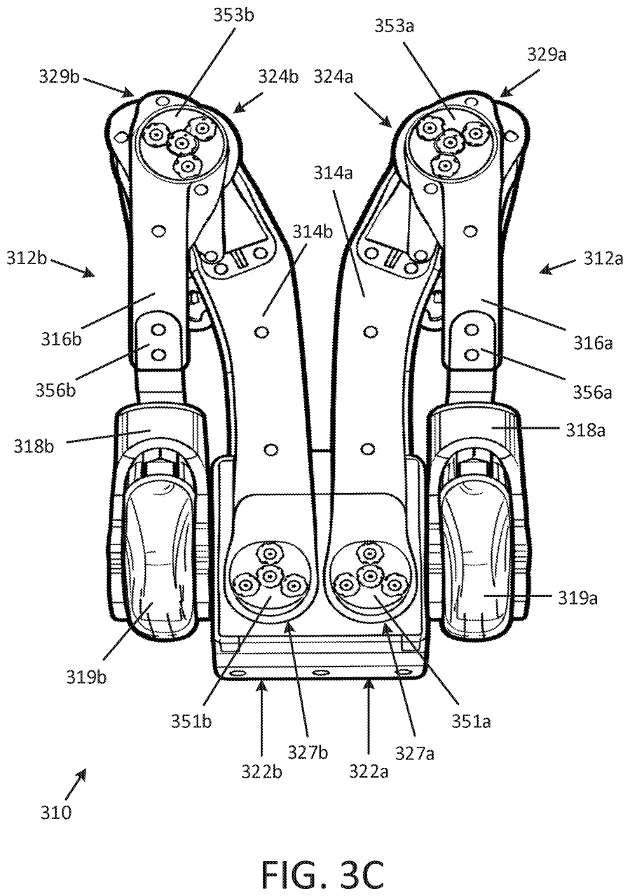

FIGS. 3A-C illustrate a vehicle-stabilizing arm assembly, in accordance with one or more implementations. FIG. 3A illustrates a perspective view of an arm assembly 310. In FIG. 3A, the arm assembly 310 includes a left stabilizing arm arrangement 312a, a right stabilizing arm arrangement 312b, a left proximal actuator 322a, a right proximal actuator 322b, a left distal actuator 324a, a right distal actuator 324b, and mount 335, and a reinforcement mount 336. The left stabilizing arm arrangement 312a and the right stabilizing arm arrangement 312b are arranged on opposing sides of the reinforcement mount 336 and the mount 335, with the left stabilizing arm arrangement 312a positioned on a left side of the arm assembly 310 and the right stabilizing arm arrangement 312b positioned on a right side of the arm assembly 310.

In this example, the left stabilizing arm arrangement 312a includes a left proximal arm 314a, a left proximal reinforcement arm 315a, a left distal arm 316a, a left distal reinforcement arm 317a, a left wheel assembly 318a including a left wheel 319a, a left wheel assembly swivel 320a, a left support bracket 323a, a left proximal joint 327a, a left distal joint 329a, a left proximal planetary gearbox cover 331a housing a left proximal planetary gearbox, and a left distal planetary gearbox cover 333a housing a left distal planetary gearbox. In some implementations, the left proximal arm 314a and the left proximal reinforcement arm 315a are integrated into a single component. In some implementations, the left distal arm 316a and the left distal reinforcement arm 317a are integrated into a single component. Integration into a single component may be more complex to manufacture but may reduce the time or cost of assembly.

Likewise, the right stabilizing arm arrangement 312b includes a right proximal arm 314b, a right proximal reinforcement arm 315b, a right distal arm 316b, a right distal reinforcement arm 317b, a right wheel assembly 318b including a right wheel 319b, a right wheel assembly swivel 320b, a right support bracket 323b, a right proximal joint 327b, a right distal joint 329b, a right proximal planetary gearbox cover 331b housing a right proximal planetary gearbox, and a right distal planetary gearbox cover 333b housing a right distal planetary gearbox. In some implementations, the right proximal arm 314b and the right proximal reinforcement arm 315b are integrated into a single component. In some implementations, the right distal arm 316b and the right distal reinforcement arm 317b are integrated into a single component. Integration into a single component may be more complex to manufacture but may reduce the time or cost of assembly.

The left stabilizing arm arrangement 312a is arranged on a left side of the arm assembly 310. The left proximal arm 314a extends upward from the mount 335 and is coupled to the mount 335 at the left proximal joint 327a via the left proximal planetary gearbox. The left proximal reinforcement arm 315a is arranged adjacent to the left proximal arm 314a and extends along the left proximal arm 314a to provide support. The left distal arm 316a is positioned outward of the left proximal arm 314a and is coupled to the left proximal arm 314a at the left distal joint 329a via the left distal planetary gearbox. The left distal reinforcement arm 317a is arranged adjacent to the left distal arm 316a to provide support. The left support bracket 323a is attached to an upper region of the left proximal arm 314a. The left distal arm 316a is positioned in between the left support bracket 323a and the upper region of the left proximal arm 314a, such that the left support bracket 323a provides additional support to the left distal joint 329a.

Likewise, the right stabilizing arm arrangement 312b is arranged on a right side of the arm assembly 310. The right proximal arm 314b extends upward from the mount 335 and is coupled to the mount 335 at the right proximal joint 327b via the right proximal planetary gearbox. The right proximal reinforcement arm 315b is arranged adjacent to the right proximal arm 314b and extends along the right proximal arm 314b to provide support. The right distal arm 316b is positioned outward of the right proximal arm 314b and is coupled to the right proximal arm 314b at the right distal joint 329b via the right distal planetary gearbox. The right distal reinforcement arm 317b is arranged adjacent to the right distal arm 316b to provide support. The right support bracket 323b is attached to an upper region of the right proximal arm 314b. The right distal arm 316b is positioned in between the right support bracket 323b and the upper region of the right proximal arm 314b, such that the right support bracket 323b provides additional support to the right distal joint 329b.

The left wheel assembly 318a is positioned at a lower (distal) end region of the left distal arm 316a. The left wheel 319a is housed by the left wheel assembly 318a, which may include a wheel cover, a wheel axle, bearings, or the like. The left wheel assembly 318a includes a left wheel swivel 320a that allows the left wheel 319a to pivot around a vertical axis relative to the left distal arm 316a. The right wheel assembly 318b is positioned at a lower (distal) end region of the right distal arm 316b. The right wheel 319b is housed by the right wheel assembly 318b, which may include a wheel cover, a wheel axle, bearings, or the like. The right wheel assembly 318b includes a right wheel swivel 320b that allows the right wheel 319b to pivot around a vertical axis relative to the right distal arm 316b.

In the example, the mount 335 spans the left proximal arm 314a and the right proximal arm 314b laterally and serves as a common structural base from which the arm arrangements 312a, 312b extend. In use, the mount 335 may be coupled to a vehicle to facilitate vehicle stabilization using the arm assembly 310. The reinforcement mount 336 is positioned behind the mount 335 and spans laterally between the left stabilizing arm arrangement 312a and the right stabilizing arm arrangement 312b near the left proximal actuator 322a and the right proximal actuator 322b to provide additional structural support for the mount 335, the left stabilizing arm arrangement 312a, and/or the right stabilizing arm arrangement 312b.

In some implementations, separate mounts may be used for the left arm arrangement 312a and the right arm arrangement 312b. For example, a left mount coupled to a vehicle may serve as a structural base for a left arm arrangement 312a, and a right mount coupled to the vehicle may serve as a structural base for a right arm arrangement 312b. In such implementations, a left reinforcement mount may be positioned behind the left mount and a right reinforcement mount may be positioned behind the right mount to provide additional structural support for the left mount, the right mount, the left stabilizing arm arrangement 312a, and/or the right stabilizing arm arrangement 312b.

FIG. 3B illustrates the arm assembly 310 with protective covers included. In FIG. 3B, a left proximal cover 342a covers the left proximal arm 314a, and a left distal cover 344a covers the left distal arm 316a. Likewise, a right proximal cover 342b covers the right proximal arm 314b, and a right distal cover 344b covers the right distal arm 316b.

In this example, the protective covers 342a, 342b, 344a, 344b are arranged to house wiring associated with the stabilizing arm assembly 310. The protective covers 342a, 342b, 344a, 344b position cables associated with the left proximal actuator 322a, the left distal actuator 324a, the right proximal actuator 322b, and the right distal actuator 324b along defined paths relative to the left proximal arm 314a, the left distal arm 316a, the right proximal arm 314b, and the right distal arm 316b, respectively. In the example, routing of the wiring by the protective covers results in the wiring being protected from environmental conditions and being positioned away from moving interfaces including the left proximal joint 327a, the left distal joint 329a, the right proximal joint 327b, and the right distal joint 329b.

In FIG. 3B, a left alignment bracket 348a is coupled to or integrated with the left wheel assembly 318a. Likewise, a right alignment bracket 348b is coupled to or integrated with the right wheel assembly 318b.

In the example, the left alignment bracket 348a and the right alignment bracket 348b are arranged to orient the left wheel assembly 318a and the right wheel assembly 318b, respectively, into retraction positions during movement of the corresponding stabilizing arm arrangements 312a, 312b toward retracted states. In some implementations, the left alignment bracket 348a includes a magnetic element carried by the left wheel assembly 318a, and the right alignment bracket 348b includes a magnetic element carried by the right wheel assembly 318b. In this example, corresponding magnetic elements are positioned on adjacent portions of the distal arms 316a, 316b or on adjacent portions of the distal covers 344a, 344b, so that as the left stabilizing arm arrangement 312a and/or the right stabilizing arm arrangement 312b move toward retracted states, magnetic interaction between the magnets biases the left wheel assembly 318a and/or the right wheel assembly 318b toward predetermined rotational orientations.

In one implementation, the predetermined rotational orientations align the left wheel assembly 318a and the right wheel assembly 318b with corresponding retraction paths so that the left wheel assembly 318a and the right wheel assembly 318b fit within the lateral profile of a vehicle that the arm assembly 310 is mounted to, via mount 335, when the arm assembly 310 is fully retracted.

In other implementations, the stabilizing arm assembly 310 may include one or more additional actuators coupled to the left wheel assembly 318a and/or the right wheel assembly 318b to control rotational orientation of one or more corresponding wheels 319a, 319b. In such implementations, an actuator is positioned proximate to the left wheel swivel 320a and/or the right wheel swivel 320b to drive rotation of the corresponding wheel assembly(ies) 318a, 318b. In this example, the additional actuator(s) positions the left wheel 319a and/or the right wheel 319b into a retraction orientation during retractive movement of the stabilizing arm arrangement(s).

FIG. 3C illustrates a profile view of the back of the arm assembly 310. As illustrated by FIG. 3C, the left proximal planetary gearbox 351a and the right proximal planetary gearbox 351b are positioned at the left proximal joint 327a and the right proximal joint 327b, respectively, and are interposed between the mount 335 and the respective proximal arms 314a, 314b. The left distal planetary gearbox 353a and the right distal planetary gearbox 353b are positioned at the left distal joint 329a and the right distal joint 329b, respectively, and are interposed between the proximal arms 314a, 314b and the distal arms 316a, 316b. In the example, the planetary gearboxes 351a, 351b, 353a, 353b are aligned with rotational axes defined by the corresponding joints 327a, 327b, 329a, 329b.

In the example, the left proximal planetary gearbox 351a, the left distal planetary gearbox 353a, the right proximal planetary gearbox 351b, and the right distal planetary gearbox 353b are configured to increase torque transmitted from the corresponding actuators to the left proximal arm 314a, the left distal arm 316a, the right proximal arm 314b, and the right distal arm 316b, respectively. The left proximal actuator 322a and the right proximal actuator 322b transmit rotational input through the left proximal planetary gearbox 351a and the right proximal planetary gearbox 351b, respectively, and the left distal actuator 324a and the right distal actuator 324b transmit rotational input through the left distal planetary gearbox 353a and the right distal planetary gearbox 353b, respectively. In the example, the planetary gearboxes provide a reduction ratio that results in increased output torque at the left proximal joint 327a, the left distal joint 329a, the right proximal joint 327b, and the right distal joint 329b, such that the stabilizing arm assembly 310 is driven against loads associated with supporting the scooter. In this way, the planetary gearboxes 351a, 351b, 353a, 353b may facilitate use of actuators with a smaller form factor suitable for fitting within a lateral width of a narrow-bodied vehicle such as a scooter.

As shown, the mount 335 is positioned at a lower (proximal) central region of the arm assembly 310. The mount 335 is coupled to the left proximal planetary gearbox 351a at the left proximal joint 327a and to the right proximal planetary gearbox 351b at the right proximal joint 327b.

The left proximal actuator 322a is coupled to the left proximal planetary gearbox 351a. The left proximal actuator 322a drives the left proximal planetary gearbox 351a to rotate the left proximal arm 314a relative to the mount 335 at the left proximal joint 327a. The left distal actuator 324a is coupled to the left distal planetary gearbox 353a. The left distal actuator 324a drives the left distal planetary gearbox 353a to rotate the left distal arm 316a relative to the left proximal arm 314a at the left distal joint 329a.

The right proximal actuator 322b is coupled to the right proximal planetary gearbox 351b. The right proximal actuator 322b drives the right proximal planetary gearbox 351b to rotate the right proximal arm 314b relative to the mount 335 at the right proximal joint 327b. The right distal actuator 324b is coupled to the right distal planetary gearbox 353b. The right distal actuator 324b drives the right distal planetary gearbox 353b to rotate the right distal arm 316b relative to the right proximal arm 314b at the right distal joint 329b.

The left wheel assembly mount 356a is positioned between and couples the left distal arm 316a and the left wheel assembly 318a. The right wheel assembly mount 356b is positioned between and couples the right distal arm 316b and the right wheel assembly 318b.

### 5. Example Vehicle Having Stabilizing Arm and Steering System Assemblies

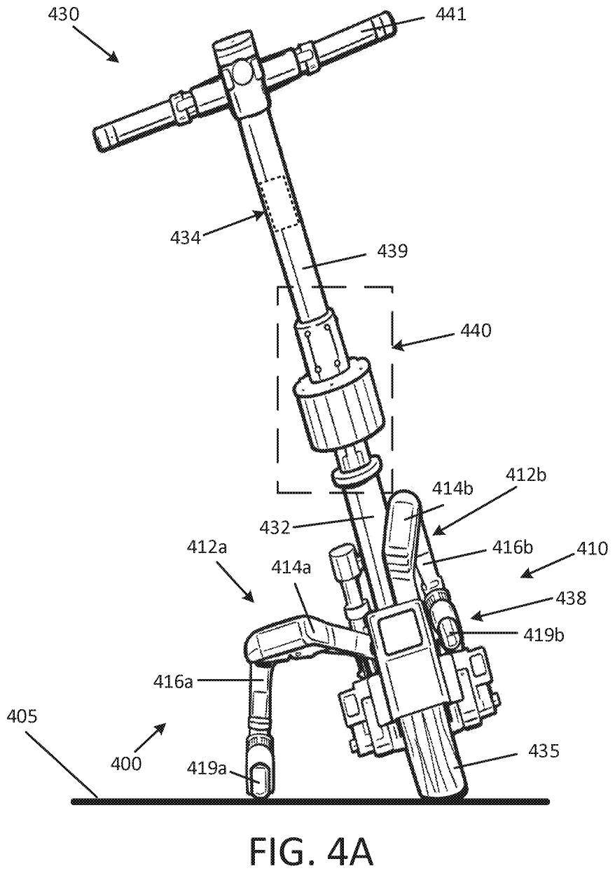

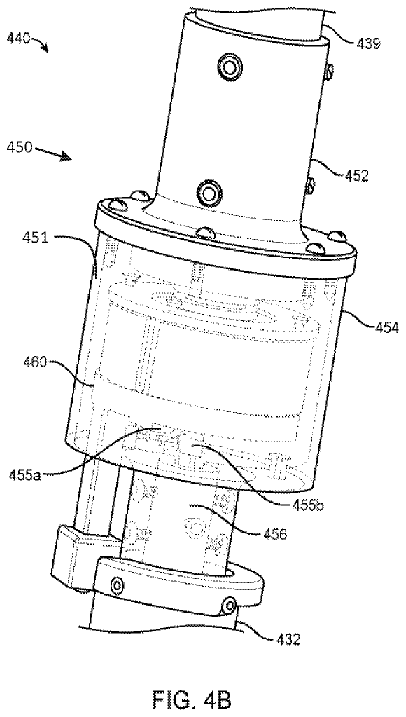

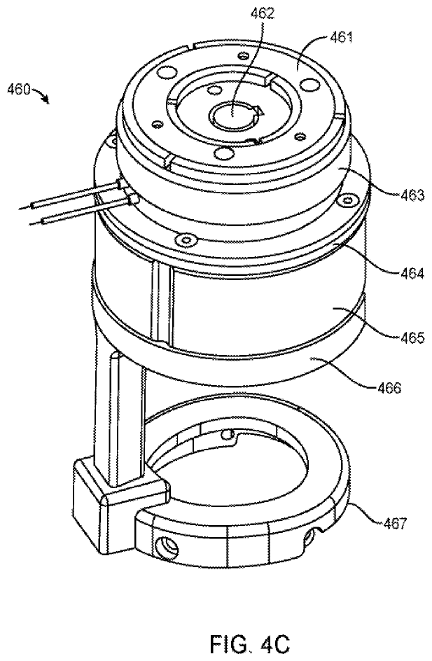

FIGS. 4A-C illustrate a scooter having a stabilizing arm assembly and a steering system assembly, in accordance with one or more implementations. FIG. 4A illustrates a scooter with a stabilizing arm assembly having a left stabilizing arm in a deployed state. In FIG. 4, a self-stabilizing vehicle system 400 includes a stabilizing arm assembly 410 and a scooter 430. The scooter 430 further includes a steering system assembly 440.

As shown, the stabilizing arm assembly 410 includes a left stabilizing arm arrangement 412a and a right stabilizing arm arrangement 412b.

The left stabilizing arm arrangement 412a includes a left proximal arm 414a, a left distal arm 416a, and a left ground-engaging member 419a. Likewise, the right stabilizing arm arrangement 412b includes a right proximal arm 414b, a right distal arm 416b, and a right ground-engaging member 419b.

As shown, the scooter 430 includes a scooter body 432, an electronics unit 434, a rear wheel 435, a footboard 438, a vertical portion 439, the steering system assembly 440, and a handle 441.

The rear wheel 435 is positioned at a rear region of the scooter 430, below the scooter body 432, and opposite a front wheel (not shown). In the example, the rear wheel 435 and front wheel support the scooter 430 on the ground surface 405. The footboard 438 is positioned along a lower region of the scooter 430 and extends between the rear wheel 435 and the front wheel and vertical portion 439.

The vertical portion 439 is illustrated as a stem that extends upward from a forward region of the scooter 430. In the example, the vertical portion 439 supports the handle 441. The handle 441 is positioned at an upper region of the vertical portion 439. The vertical portion 439 and the handle 441 may be referred to together as a steering column assembly or a stem/handlebar assembly. In the example, the handle 441 is illustrated as a handlebar that extends laterally across the vertical portion 439. The steering system assembly 440 is configured to provide both electronic and manual steering of the scooter 430 by selectively engaging an electromagnetic clutch. The handle 441 may facilitate manual steering of the scooter by a user when the clutch of the steering system assembly 440 is disengaged.

In this example, the electronics unit 434 includes an inertial measurement unit (IMU) and a control system. In various implementations, the electronics unit 434 may also include components for interfacing with a charging station, an operator dashboard, a mobile app, and/or cloud infrastructure. The IMU generates orientation data indicative of an orientation of the scooter 430, and the control system receives the orientation data from the IMU. In this example, the control system has processed the orientation data to determine that the scooter 430 is tilted toward a left side.

In response to determining that the tilt exceeds a threshold angle, the control system actuates the stabilizing arm assembly 410 such that the left stabilizing arm arrangement 412a moves from a retracted state toward a deployed state. The control system drives a left set of actuators of the stabilizing arm assembly 410 to move the left proximal arm 414a relative to the scooter body 432 and to move the left distal arm 416a relative to the left proximal arm 414a. In the example, movement of the left proximal arm 414a and the left distal arm 416a positions the left ground-engaging member 419a onto a ground surface 405.

The left ground-engaging member 419a contacts the ground surface 405 while the scooter 430 remains tilted but before the scooter 430 fully tips over. The control system continues driving the left stabilizing arm arrangement 412a such that the left proximal arm 414a and the left distal arm 416a support the scooter 430 in a partially tilted condition. In the example, contact between the left ground-engaging member 419a and the ground surface 405 results in the scooter 430 not reaching a fully tipped state.

After a period of time, the control system may further actuate the stabilizing arm assembly 410 to reduce the tilt of the scooter 430. For example, the control system adjusts positions of the left proximal arm 414a and the left distal arm 416a to straighten the scooter 430 and also drives the right stabilizing arm arrangement 412b from a retracted state toward a deployed state. In the example, the control system moves the right proximal arm 414b relative to the scooter body 432 and moves the right distal arm 416b relative to the right proximal arm 414b to the deployed state whereby the right ground-engaging member 419b is in contact with the ground surface 405.

The control system continues controlling the left stabilizing arm arrangement 412a and the right stabilizing arm arrangement 412b such that the left ground-engaging member 419a and the right ground-engaging member 419b engage the ground surface 405 while the scooter 430 is brought toward an upright condition. In the example, coordinated actuation of the left stabilizing arm arrangement 412a and the right stabilizing arm arrangement 412b results in the scooter 430 being supported by the stabilizing arm assembly 410, in a fully upright position, with both ground-engaging members in contact with the ground surface 405. Although the ground surface 405 is illustrated as substantially horizontal in the example, the ground surface 405 may be angled. Regardless of the angle of the ground surface, the stabilizing arm assembly 410 may prevent the scooter 430 from tipping fully over.

The control system maintains a partially deployed state of a single stabilizing arm arrangement for a duration while monitoring the orientation data and/or other sensor data. In one example, the control system determines that the tilt condition has persisted for a threshold duration and, in response to the tilt condition persisting for the threshold duration, transitions the stabilizing arm assembly 410 to a fully deployed configuration. The control system drives both the left stabilizing arm arrangement 412a and the right stabilizing arm arrangement 412b into contact with the ground surface 405 and restricts movement of the scooter 430. In the example, actuation of both stabilizing arm arrangements 412a, 412b results in the scooter 430 being positioned in an upright condition. In cases where the ground surface 405 is inclined, the stabilizing arm arrangements 412a, 412b may be deployed asymmetrically so that the scooter 430 is fully upright.

In the example, once the scooter 430 is in a fully upright condition, the stabilizing arm arrangements 412a, 412b may remain deployed so that an internal friction of the stabilizing arm arrangements 412a, 412b provides resistance that results in the scooter 430 remaining static in the upright position. In other implementations, however, the control system may continue to drive one or more actuators to provide additional resistance.

FIG. 4B illustrates the steering system assembly 440. As illustrated in FIG. 4B, the steering system assembly 440 includes an external part 450 and an internal part 460. In this example, the steering system assembly 440 is configured to allow both manual and electronic steering of the scooter 430. The steering system assembly 440 is positioned coaxially with the vertical portion 439a and a front fork shaft 456 of the scooter body 432. The steering system assembly 440 includes an electromagnetic clutch that selectively couples an actuator to an outer housing. When the clutch is disengaged, the handlebar can rotate freely for rider control. When the clutch is engaged, the scooter 430 may be controlled by remote steering via motor-driven rotation. Various implementations may include variations in design, attachment points, or clutch types.

The scooter's steering assembly is split into an external part 450 and an internal part 460. The external part 450 interconnects the scooter body 432 (e.g., a front fork shaft 456 of the scooter body 432) and the vertical portion 439 (e.g., the stem which leads to the handlebar). The internal part 460 facilitates electronic, remote steering through an actuator and electromagnetic clutch. This arrangement results in selective manual or electronic operation based on whether the clutch is energized or disengaged.

In FIG. 4B, the external part 450 includes an outer housing 451, a stem mount 452, a fork mount 454, calibration switches 455a and 455b, and a front fork shaft 456. The stem mount 452 and fork mount 454 cooperate to form a generally cylindrical enclosure that permits conventional manual steering when a clutch is disengaged and enables actuator-driven steering when the clutch is engaged.

The outer housing 451 is configured to at least partially enclose and protect components of the steering system assembly, including portions of the internal part 460 and the interface between the stem mount 452 and the fork mount 454. In one embodiment, the outer housing 451 is defined by cooperating structures of the stem mount 452 and the fork mount 454 and forms a generally cylindrical enclosure surrounding the steering axis. The outer housing 451 is configured to shield internal components from environmental exposure, including water, debris, and contaminants, while maintaining sufficient clearance to permit relative rotation between the external part 450 and the internal part 460. In some implementations, the outer housing 451 further provides structural support and alignment for the steering system assembly 440 while maintaining a compact form factor compatible with a narrow-profile vehicle.

The stem mount 452 is configured to attach to the scooter stem and transmit steering inputs to the front fork shaft 456. In one embodiment, the stem mount 452 is formed as a generally circular or cylindrical lid that is secured to the fork mount 454 to at least partially enclose the external part 450. An underside portion of the stem mount 452 includes a clutch interface surface configured to selectively engage an electromagnetic clutch. When the clutch is energized, the clutch interface is drawn into frictional engagement with a rotating element coupled to an actuator, resulting in motor-driven rotation of the stem mount 452 and corresponding steering of the front fork shaft 456. When the clutch is disengaged, the stem mount 452 rotates freely with minimal resistance, allowing conventional rider-controlled steering.

The fork mount 454 is rigidly coupled to the front fork shaft 456 and forms a structural enclosure for internal steering components. The fork mount 454 may be formed as a generally cylindrical or tubular body sized to house an actuator, clutch components, and associated mounts. In one embodiment, the fork mount 454 includes an opening extending along a circumferential portion thereof to permit passage of an internal actuator mount that is fixed relative to the scooter body 432. The fork mount 454 further includes a central bore aligned with the front fork shaft 456 to allow routing of cables, wiring, or other connections between internal components and downstream electronics. A mating interface between the fork mount 454 and the stem mount 452 is configured to inhibit ingress of water, debris, and contaminants.

The calibration switches 455a and 455b are positioned at opposing ends of the opening in the fork mount 454 and are configured to provide positional feedback corresponding to rotational limits of the external part 450. During operation, a stationary internal structure engages one of the calibration switches 455a or 455b when the stem mount 452 and fork mount 454 rotate to a corresponding steering limit. Activation of a calibration switch 455a or 455b provides a signal to a control system indicating that a maximum steering angle has been reached. The signal may result in preventing over-rotation and may be used for recalibration of actuator position, such as by facilitating alignment of an internal encoder.

The front fork shaft 456 extends through the fork mount 454 and is mechanically coupled to a front wheel assembly of the scooter 430. The front fork shaft 456 rotates in response to rotation of the stem mount 452 to transfer steering inputs into directional changes of the front wheel. When electronic steering is used, rotational torque may be imparted to the front fork shaft 456 through selective engagement of the clutch interface, such that an actuator drives steering motion. The front fork shaft 456 may additionally serve as a passage for routing electrical wiring or communication lines between the enclosed steering components and other portions of the scooter.

In operation, the external part 450 supports multiple modes of use. In a manual mode, the electromagnetic clutch remains disengaged, allowing the stem mount 452 and fork mount 454 to rotate together freely so that a user can steer the scooter conventionally with minimal additional friction. In a remote or autonomous mode, a control unit energizes the electromagnetic clutch to couple the actuator to the stem mount 452, such that torque commands from an operator or control system may be used to rotate the handle 441 and front fork shaft 456. The calibration switches 455a and 455b provide limit detection and reference points for alignment during such operation. In an idle or maintenance mode, the clutch may remain disengaged to conserve power, and the external part 450 can be disassembled by separating the stem mount 452 from the fork mount 454 to access internal components.

FIG. 4C illustrates the internal part 460. As shown, the internal part 460 includes a clutch pad 461, a shaft adapter 462, an electromagnetic clutch 463, a clutch adapter 464, a steering actuator 465, an actuator mount 466, and a collar mount 467. The internal part 460 is configured to provide motor-driven steering control while remaining non-rotating relative to the scooter body 432, except for torque transfer occurring at a clutch interface with the external part 450. In this manner, the internal part 460 facilitates selective coupling between the actuator 465 and the handle 441.

The clutch pad 461 is configured as an armature interface for the electromagnetic clutch 463 and is positioned to engage a rotating portion of the clutch when energized. In one embodiment, the clutch pad 461 is affixed to an underside portion of the stem mount such that rotation of the clutch pad 461 corresponds to rotation of the handle 441 and the associated front fork assembly. The clutch pad 461 may include a friction material or composite surface configured to provide consistent torque transfer when engaged. In certain implementations, the clutch pad 461 is mounted via a flexible support, such as a spring steel plate, that permits slight deflection during engagement to ensure uniform contact and reduce uneven wear.

The shaft adapter 462 is configured to mechanically couple a drive shaft of the steering actuator 465 to a rotor portion of the electromagnetic clutch 463. In one embodiment, the shaft adapter 462 includes a keyed, splined, or shaped interface to facilitate positive torque transmission and prevent slippage under high load conditions. When the electromagnetic clutch 463 is disengaged, the shaft adapter 462 permits rotation of the actuator shaft without imparting motion to the clutch pad 461, such that the external steering components may rotate freely. When the clutch is engaged, the shaft adapter 462 transmits rotational torque from the actuator to the clutch assembly.

The electromagnetic clutch 463 is configured to selectively couple rotational motion from the steering actuator 465 to the clutch pad 461. The electromagnetic clutch 463 includes a coil configured to generate a magnetic field when energized, thereby drawing a rotor into frictional engagement with the clutch pad 461 to transmit torque. When de-energized, the clutch 463 disengages such that the external part 450 may rotate relative to the internal part 460. The electromagnetic clutch 463 may be configured with a slip characteristic that permits relative motion under excessive torque, thereby protecting the steering actuator 465 and associated components from damage if a user forcibly rotates the handle 441 during actuator-driven operation.

The clutch adapter 464 is configured to mechanically couple the steering actuator 465 to the electromagnetic clutch 463. In one embodiment, the clutch adapter 464 secures a housing or stator portion of the electromagnetic clutch 463 relative to the steering actuator 465 and maintains alignment between the actuator output and the clutch assembly. In the example, the clutch adapter 464 includes structural features that facilitate concentric alignment along a steering axis to reduce friction and improve torque transmission efficiency.

The steering actuator 465 is configured to generate rotational torque for steering control. In one embodiment, the steering actuator 465 comprises a brushless direct current (DC) motor including an internal gear reduction, such as a planetary gear system, to increase torque output while maintaining a compact form factor. The steering actuator 465 may be capable of producing torque sufficient to rotate the front fork assembly under load. The steering actuator 465 may further include an integrated encoder configured to provide position feedback to facilitate precise control of steering angle and calibration.

The actuator mount 466 is configured to support the steering actuator 465 in a fixed position relative to the scooter body 432 while permitting the external part 450 to rotate independently. In one embodiment, the actuator mount 466 extends from the collar mount 467 and includes a stem portion that passes through an opening in the fork mount to position the steering actuator 465 within the external enclosure. The actuator mount 466 is configured to maintain alignment of the steering actuator 465 with a steering axis of the scooter 430 to minimize misalignment and reduce mechanical interference during operation. In the example, the actuator mount 466 supports the steering actuator 465 in a cantilevered arrangement within the enclosure. In other implementations, multiple stem portions are employed to reinforce the actuator mount 466. In such implementations, the multiple stem portions may be used instead of the cantilevered arrangement.

The collar mount 467 is configured to provide a rigid attachment point for the internal part 460 to the scooter body 432. In one embodiment, the collar mount 467 comprises a ring-shaped or collar-shaped structure that is affixed to the frame 432, such as by bolting, clamping, or welding. The collar mount 467 serves as a non-rotating base for the actuator mount 466 and associated components, such that the internal part 460 remains stationary relative to the scooter body 432 during steering operations. By anchoring the internal components in this manner, the collar mount 467 results in controlled torque transfer through the electromagnetic clutch 463 without requiring rotation of the actuator 465 or its supporting structure.

In one or more implementations, the steering system assembly may include and/or may be used to perform one or more of the following aspects:

Aspect 1. A steering system assembly for a scooter, including: a fork mount configured to couple to a front fork shaft of the scooter; a stem mount configured to couple to a stem of the scooter, the stem mount being rotatable with the fork mount about a steering axis; a steering actuator positioned coaxially with the steering axis; an electromagnetic clutch operatively disposed between the steering actuator and the stem mount; and an actuator mount coupled to a frame-fixed portion of the scooter and configured to support the steering actuator in a non-rotating position relative to the frame, wherein, when the electromagnetic clutch is disengaged, the stem mount and the fork mount are manually rotatable about the steering axis independently of the steering actuator; and when the electromagnetic clutch is engaged, torque from the steering actuator is transferred through the electromagnetic clutch to the stem mount to rotate the stem mount and the fork mount about the steering axis.

Aspect 2. The steering system assembly of Aspect 1, further including the stem mount and the fork mount cooperatively defining an enclosure surrounding at least the steering actuator and the electromagnetic clutch.

Aspect 3. The steering system assembly of Aspect 1, further including first and second calibration switches positioned to be selectively contacted in response to rotation of the stem mount and the fork mount to corresponding steering-limit positions, the first and second calibration switches being configured to provide steering-limit feedback to a control unit.

Aspect 4. A scooter, including: a frame; a front wheel assembly including a front fork shaft; a handlebar assembly including a stem; and the steering system assembly of Aspect 1, wherein the fork mount is coupled to the front fork shaft; the stem mount is coupled to the stem; and the scooter is configurable in a manual steering mode in which the electromagnetic clutch is disengaged and in an electronic steering mode in which the electromagnetic clutch is engaged.

Aspect 5. The scooter of Aspect 4, further including a control unit configured to selectively energize and de-energize the electromagnetic clutch to switch between the manual steering mode and the electronic steering mode.

Aspect 6. The scooter of Aspect 5, wherein the steering actuator includes an encoder, and wherein the control unit is configured to determine or reset a steering position based at least in part on signals from one or more calibration switches associated with steering-limit positions.

Aspect 7. A method of controlling steering of a scooter having a front fork shaft and a handlebar stem, the method including: supporting, by a frame-fixed actuator mount, a steering actuator in a non-rotating position relative to a frame of the scooter; providing, between the steering actuator and the handlebar stem, an electromagnetic clutch; while the electromagnetic clutch is disengaged, permitting manual rotation of the handlebar stem and the front fork shaft about a steering axis independently of the steering actuator; and while the electromagnetic clutch is engaged, driving the handlebar stem and the front fork shaft about the steering axis by transmitting torque from the steering actuator through the electromagnetic clutch.

Aspect 8. The method of Aspect 7, further including receiving, from a remote operator interface or an autonomous control module, a steering command and, in response to the steering command, energizing the electromagnetic clutch and actuating the steering actuator to rotate the handlebar stem and the front fork shaft.

Aspect 9. The method of Aspect 7, further including detecting that the handlebar stem and the front fork shaft have reached a steering-limit position using a calibration switch, and, in response to detecting the steering-limit position, preventing further actuation in a same rotational direction and updating a steering position reference.

### 6. Vehicle Stabilization Operations

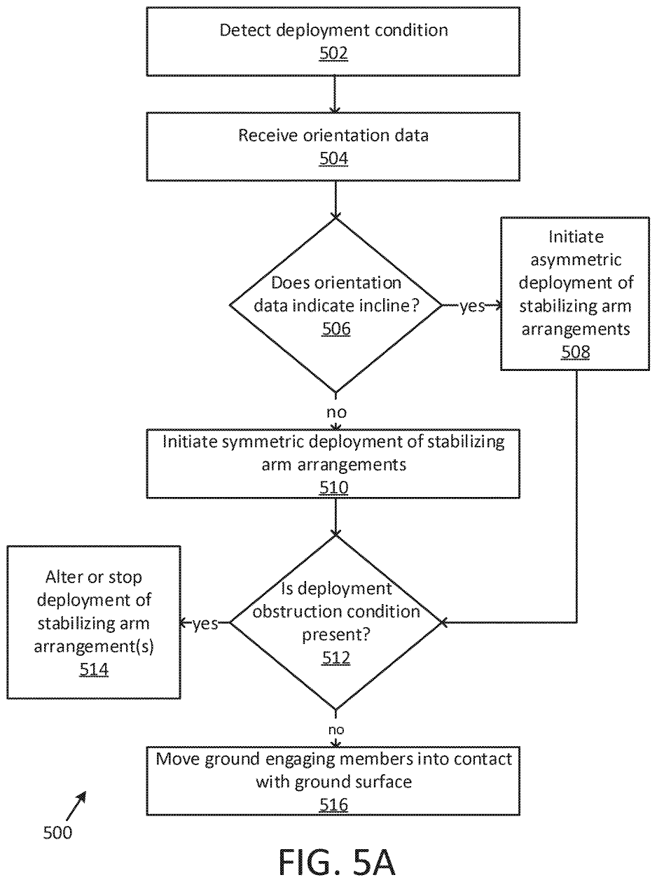

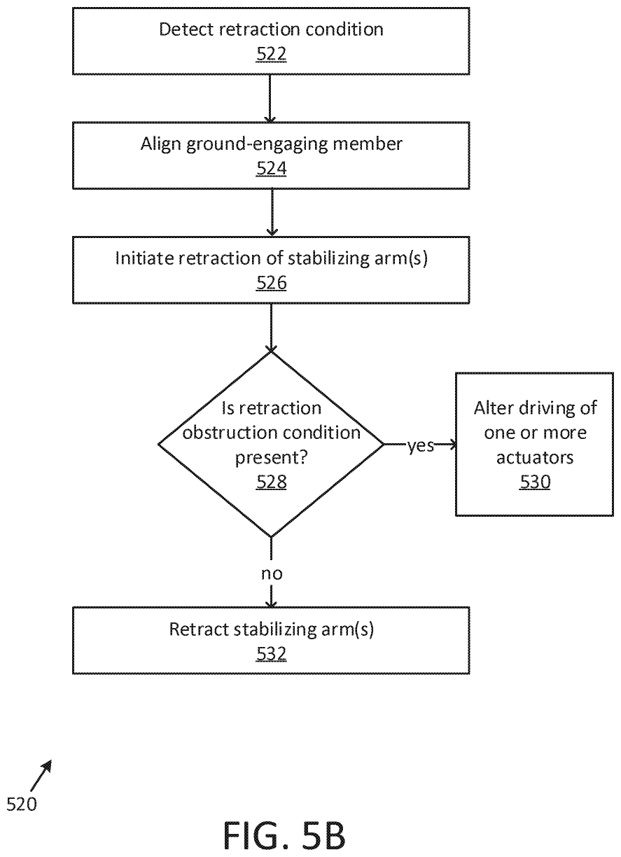

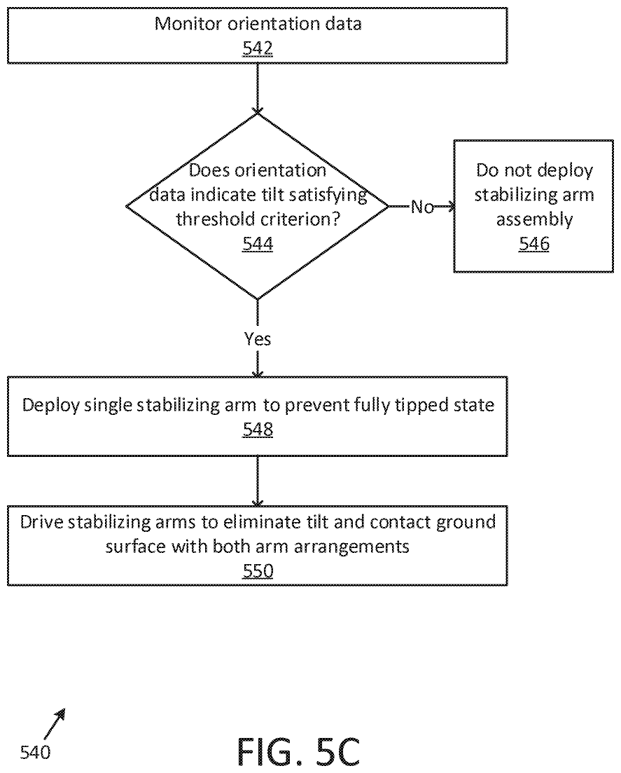

FIGS. 5A-C illustrate stabilizing arm assembly deployment and/or retraction operations, in accordance with one or more implementations. Operations described with reference to FIGS. 5A-C may be performed by a control system (e.g., an ECU) associated with a stabilizing arm assembly, such as the control unit 234 of FIG. 2, and/or by another control system. In various implementations, one or more components of the control system may be integrated into or otherwise coupled to the stabilizing arm assembly and/or integrated into or otherwise coupled to a vehicle (e.g., a scooter) to which the stabilizing arm assembly is mounted or otherwise attached. One or more operations illustrated in FIGS. 5A-C may be modified, rearranged, or omitted altogether. Accordingly, the particular sequence of operations illustrated in FIGS. 5A-C should not be construed as limiting the scope of implementations.

FIG. 5A illustrates a set of operations 500 for deploying a stabilizing arm assembly of a vehicle. The control system detects a deployment condition (Operation 502). The control system detects the deployment condition by monitoring operational states of the vehicle and determining that one or more deployment criteria are satisfied. In one or more implementations, the control system identifies the deployment condition based on the vehicle being stationary or entering a stabilization mode, such as after a ride or delivery is completed or when a scooter has reached a charging station. For example, the control system detects the deployment condition by identifying that the vehicle is parked or has stopped moving and is to be maintained in a stable position. In some implementations, the control system detects the deployment condition based on user interaction with an operator dashboard or mobile app.

The control system receives orientation data (Operation 504). The control system receives the orientation data from an inertial measurement unit (IMU) of the vehicle and/or an IMU of the stabilizing arm assembly. In one or more implementations, an IMU generates orientation data indicative of roll and/or pitch of the scooter relative to gravity and transmits the orientation data to the control system. For example, the IMU measures a tilt of the scooter and provides corresponding orientation data to the control system.

The control system determines whether the orientation data indicates an incline (Operation 506). The control system performs the determination by evaluating orientation data from the inertial measurement unit to identify whether the scooter is on an inclined surface or on a level surface. In one or more implementations, the control system analyzes the orientation data to determine the presence and/or degree of incline.

In one or more implementations, the control system distinguishes an incline condition from a tilt condition based on how orientation data from the IMU is interpreted. In one example, the control system determines that the orientation data indicates an incline when the scooter is upright relative to the ground surface, but the orientation data indicates that gravity is acting on the scooter at a non-vertical angle. In another example, the control system determines that the orientation data indicates a tilt condition when the scooter rotates away from an upright condition due to leaning or instability. Thus, in the example, the control system uses IMU data to distinguish a steady-state incline condition from a potential tip-over condition.

If the control system determines that the orientation data indicates an incline, the control system initiates asymmetric deployment of the stabilizing arm arrangements (Operation 508). In this operation, the control system responds to presence of the incline by independently controlling the first actuator set and the second actuator set such that the first stabilizing arm arrangement and the second stabilizing arm arrangement are independently moved by different amounts to account for the incline. In one or more implementations, the control system commands a first degree of deployment for the first stabilizing arm arrangement and a second degree of deployment for the second stabilizing arm arrangement, where the second degree of deployment differs from the first degree of deployment, to account for the incline. For example, the control system extends one stabilizing arm arrangement farther than the other stabilizing arm arrangement while deploying the stabilizing arm assembly on the inclined ground surface, so that ground-engaging members of both arm arrangements contact the ground surface.

If the control system determines that the orientation data does not indicate an incline, the control system initiates symmetric deployment of the stabilizing arm arrangements (Operation 510). In this operation, the control system performs symmetric deployment in response to the orientation data indicating a flat or substantially flat ground surface. In one or more implementations, the control system controls the first actuator set and the second actuator set such that the first stabilizing arm arrangement and the second stabilizing arm arrangement are moved by the same or similar amounts. For example, the control system extends the first stabilizing arm arrangement and the second stabilizing arm arrangement outwardly by similar amounts during deployment on a level ground surface, so that ground-engaging members of both arm arrangements contact the ground surface.

The control system determines whether a deployment obstruction condition is present (Operation 512). The control system performs the determination by evaluating sensor data associated with the deployment of the stabilizing arm arrangements. In one or more implementations, the control system receives proximity data from a proximity sensor and/or current data from a current sensor associated with one or more actuators. For example, the control system identifies the deployment obstruction condition by detecting an object in a deployment path based on proximity of the object and/or by detecting that an electrical current provided to an actuator exceeds a threshold current indicating that the actuator has met resistance, such as when an object present in the deployment path associated with the actuator is causing an obstruction.

If the control system determines that a deployment obstruction condition is present, the control system alters or stops deployment of one or more stabilizing arm arrangements (Operation 514). The control system performs the alteration by modifying operation of at least one actuator of the first actuator set or the second actuator set to inhibit or modify the deployment of the stabilizing arm arrangement(s). In one or more implementations, the control system reduces actuator movement, halts actuator movement, or reverses actuator movement. For example, the control system stops extension of a stabilizing arm arrangement in response to detection of an obstruction condition. In some implementations, after a delay period, the control system may re-initiate deployment of the stabilizing arm arrangement(s).

If the control system does not determine that a deployment obstruction condition is present, the control system moves the ground-engaging members into contact with a ground surface (Operation 516). In this operation, the control system moves the ground-engaging members into contact with the ground surface by controlling the first actuator set and the second actuator set to position the first stabilizing arm arrangement and the second stabilizing arm arrangement such that the respective ground-engaging members engage the ground surface. In one or more implementations, the ground-engaging members include caster wheels coupled to respective distal portions of the stabilizing arm arrangements. The control system extends the stabilizing arm arrangements by driving the actuators to cause rotation about proximal and/or distal joints until the caster wheels contact the ground surface and support the vehicle. When the vehicle is upright with the caster wheels contacting the ground surface, internal friction of the stabilizing arm assembly may be sufficient to maintain the vehicle in the upright position.

FIG. 5B illustrates a set of operations 520 for retracting a stabilizing arm assembly of a vehicle. As shown in FIG. 5B, the control system detects a retraction condition (Operation 522). In this operation, the control system identifies that the stabilizing arm assembly is to transition from a deployed state toward a retracted state. In one or more implementations, the control system detects the retraction condition by determining that the vehicle is to be transitioned from a stabilized (e.g., parked or docked) state to a travel state. For example, the control system detects the retraction condition by identifying that the vehicle is to resume movement, such as when the vehicle receives a ride or delivery request.

The control system aligns a ground-engaging member (Operation 524). In this operation, the control system facilitates alignment of a ground-engaging member, such as a wheel of a wheel assembly, into a retraction orientation. In one or more implementations, the control system causes alignment by positioning the stabilizing arm arrangement such that an alignment bracket engages a corresponding magnetic element. For example, magnetic interaction between a magnetic element of an alignment bracket and a corresponding magnetic element biases the ground-engaging member into a predetermined rotational orientation.

In one or more implementations, the control system also causes the vehicle to move forward by a small amount prior to the stabilizing arm arrangement transitioning toward the retracted state so that the ground-engaging member (e.g., wheel) rotates into the retraction orientation. For example, the control system causes the vehicle to move forward by a short distance such that the wheel assembly rotates into alignment for receipt within a body profile of the vehicle.

The control system initiates retraction of stabilizing arm arrangements (Operation 526). In this operation, the control system drives one or more actuators to begin movement of one or more stabilizing arm arrangements from fully deployed or partially deployed positions toward retracted positions. In one or more implementations, the control system drives proximal actuators and distal actuators to rotate proximal arms and distal arms toward a center of the vehicle. For example, the control system drives planetary gearboxes via the actuators to rotate joints that move the stabilizing arm arrangements inward.

The control system determines whether a retraction obstruction condition is present (Operation 528). In this operation, the control system evaluates sensor data associated with retraction of the stabilizing arm arrangements. In one or more implementations, the control system evaluates data from a proximity sensor or a current sensor associated with one or more actuators. For example, the control system identifies a retraction obstruction condition by detecting an object in a retraction path and/or by detecting an electrical current satisfying a threshold condition indicative of resistance.

If a retraction obstruction condition is present, the control system alters driving of one or more actuators (Operation 530). Responsive to the retraction obstruction condition being present, the control system modifies operation of at least one actuator associated with the stabilizing arm arrangements. In one or more implementations, the control system reduces, stops, or reverses actuator driving. For example, the control system stops rotation of a planetary gearbox in response to detection of the retraction obstruction condition. In some implementations, the control system may retry retraction one or more times after a delay period.

If a retraction obstruction is not present, the control system retracts one or more stabilizing arm arrangements (Operation 532). Responsive to the retraction obstruction condition not being present, the control system continues driving the one or more actuators to move the stabilizing arm arrangement(s) toward fully retracted positions. In one or more implementations, the control system drives proximal actuators and distal actuators to position the stabilizing arm arrangements within a lateral profile of the vehicle. For example, the control system rotates proximal arms and distal arms about proximal and distal joints such that the arms and ground-engaging members are positioned within a lateral body profile of the vehicle.

FIG. 5C illustrates a set of operations 540 for preventing a fully tipped state and eliminating tilt of a vehicle using a stabilizing arm assembly. As shown in FIG. 5C, the control system monitors orientation data (Operation 542). In this operation, the control system receives and evaluates orientation data from an IMU of the vehicle. In one or more implementations, the IMU generates orientation data indicative of roll and/or pitch of the vehicle relative to gravity (e.g., relative to a downward direction) and transmits the orientation data to the control system. In some implementations, the control system continuously processes the orientation data to identify changes in and/or to monitor orientation of the vehicle.

The control system determines whether the orientation data indicates tilt satisfying a threshold criterion (Operation 544). In this operation, the control system compares the orientation data to one or more threshold values corresponding to a leaning condition of the vehicle. In one or more implementations, the control system evaluates whether the orientation data exceeds a predefined threshold associated with a tipping condition. For example, the control system determines that the orientation data satisfies the threshold criterion when the vehicle is leaning beyond a specified angle. In various implementations, the specified angle is determined based on an angle at which the vehicle will fully tip over and is less than the angle at which the vehicle will fully tip over.

In some implementations, the control system evaluates a movement state of the scooter in conjunction with the orientation data. For example, the control system determines whether the scooter is stationary based on whether data from an electronics unit of the scooter indicates that the scooter is moving. The control system initiates deployment of the stabilizing arm arrangement if the scooter is stationary but may not initiate deployment if the scooter is moving. In some implementations, the control system is configured to refrain from initiating deployment of the stabilizing arm assembly when the scooter is moving. In other implementations, the system may be configured such that the assembly is deployed when the scooter is moving, so that the assembly provides training-wheel like stability during movement.

In one or more implementations, the control system evaluates the orientation data to determine whether the scooter is in a fully tipped condition relative to the ground surface. In one example, the control system determines that the scooter is positioned on a side (e.g., is fully tipped over) based on the orientation data indicating a non-upright orientation. The control system refrains from actuating the stabilizing arm assembly in response to determining that the scooter is fully tipped over.

If the orientation data does not indicate a tilt satisfying the threshold criterion, the control system does not deploy the stabilizing arm assembly (Operation 546). Responsive to the orientation data not satisfying the threshold criterion, the control system maintains the stabilizing arm arrangements in a current state (e.g., a retracted state) without initiating deployment of the stabilizing arm arrangements. For example, the control system refrains from actuating the stabilizing arm arrangements when the orientation data indicates that the vehicle is within the threshold criterion (e.g., indicating uprightness).

If the orientation data does indicate a tilt satisfying the threshold criterion, the control system deploys a single stabilizing arm arrangement to prevent a fully tipped state (Operation 548). Responsive to the orientation data satisfying the threshold criterion, the control system drives one or more actuators associated with the stabilizing arm arrangement positioned on the side corresponding to the tilt to prevent or reduce further tilt to that side. The control system deploys the stabilizing arm arrangement on the side toward which the vehicle is leaning by extending the stabilizing arm arrangement on that side to contact a ground surface and prevent the vehicle from fully tipping over.

The control system drives the stabilizing arm arrangements to eliminate tilt and contact a ground surface with both arm arrangements (Operation 550). In this operation, the control system drives one or more actuators to extend the stabilizing arm arrangements such that the vehicle is uprighted and both ground-engaging members contact the ground surface. For example, the control system further drives the single stabilizing arm arrangement after initial deployment of the single stabilizing arm arrangement to reduce tilt of the vehicle to cause the vehicle to be upright and drives the other stabilizing arm arrangement such that the vehicle is supported in an upright, stable position with both ground-engaging members in contact with the ground surface. In some implementations, the control system may drive a single stabilizing arm arrangement to upright a vehicle that has been fully tipped over. For example, IMU data may be used to determine that the vehicle has fully tipped over and to determine which side of the vehicle is downward-facing. The stabilizing arm arrangement on the downward-facing side may be deployed to upright the vehicle. Once the vehicle is upright, both stabilizing arm arrangements may be deployed to engage the ground surface to provide stability to the uprighted vehicle.

### 7. Control Architecture for Stabilizing Arm Assembly

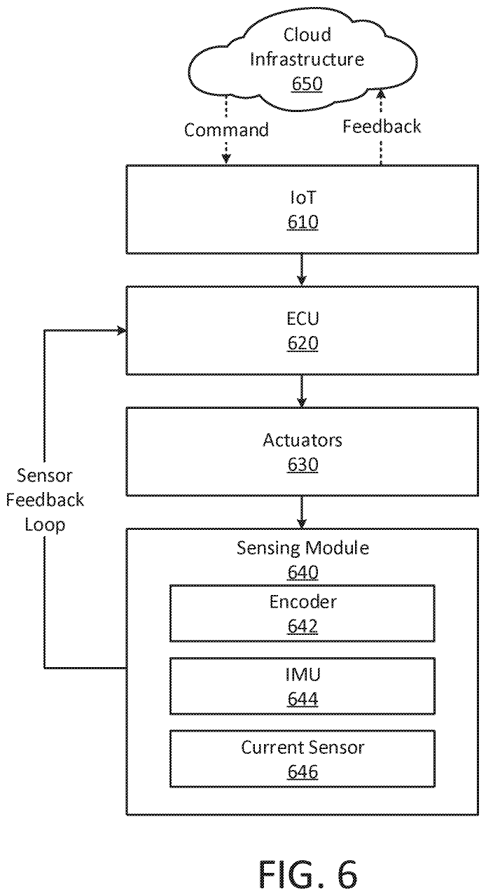

FIG. 6 illustrates a control architecture for a stabilizing arm assembly, in accordance with one or more implementations. In one or more embodiments, the control architecture may include more or fewer components than the components illustrated in FIG. 6. The components illustrated in FIG. 6 may be local to or remote from each other. The components illustrated in FIG. 6 may be implemented in software and/or hardware. Each component may be distributed over multiple applications and/or machines. Multiple components may be combined into one application and/or machine. Operations described with respect to one component may instead be performed by another component.

In various control architecture implementations, one or more ECUs may be located within a head of a scooter (e.g., a “head ECU”), near the top of a vertical stem and proximate a handlebar assembly of the scooter. One or more ECUs may be located within a frame of a scooter (e.g., a “bridge ECU”), near a bottom-front area or within a lower part of a stem of the scooter body. One or more motor control units (MCUs) may be located within the scooter frame near a front and/or rear wheel assembly. In some implementations, a main ECU receives sensor data from a head ECU and a bridge ECU, generates commands for an MCU, and communicates with the IoT module to facilitate remote operation. Further divisions or integrations (e.g., combining or further dividing the bridge and head ECUs) may be implemented depending on the implementation.

In one example, a head ECU is positioned in or near the handlebar assembly and manages user input and upper-mounted components. It receives throttle and brake inputs and transmits corresponding signals to a main ECU for control of speed and braking. The head ECU may also control lighting components, including a headlamp and turn indicators, and may support a wireless charging module for user devices. Communication with the main ECU is performed via a dedicated interface, such as a CAN bus or similar link.

Continuing the example, a bridge ECU is located in a front or midsection of the scooter and manages steering, stabilization, and environmental sensing subsystems. It interfaces with the steering system to control an electromagnetic clutch and associated actuators and/or manages deployment of stabilizing arms based on sensor inputs and commands from the main ECU. The bridge ECU may also process or relay data from sensors such as LiDAR and transmit safety-critical signals, including overcurrent conditions, to the main ECU for corrective action.

Continuing the example, the main ECU serves as a central control unit and coordinates operation of the scooter. It receives inputs from the head ECU, bridge ECU, and/or additional onboard sensors, such as a current sensor and/or an IMU. In this example, the main ECU communicates with an MCU to regulate propulsion and braking, and with an IoT module for telemetry and remote operation. The main ECU executes high-level control logic, including ride authorization, speed regulation, and safety responses, such as limiting speed or actuating stabilizing mechanisms based on sensor data.

In FIG. 6, the control architecture includes an IoT module 610, an ECU 620, actuators 630, a sensing module 640 and cloud infrastructure 650. In this example, the IoT module 610 receives a target state from the cloud infrastructure 650 and forwards a corresponding command to the ECU 620.

In this example, the cloud infrastructure 650 transmits the target operational state to the scooter through the IoT module 610, which may be on-board the scooter, or to another communication unit. In various implementations, the desired operational state includes an idle state, a maintain-upright state, and/or a retract-stabilizer state. In some implementations, the desired operational state may include an electronic steering or manual steering state. The IoT module 610 may receive commands associated with remote steering and/or stabilizing arm assembly deployment via the cloud infrastructure 650. In other implementations, additional states, modes, or control objectives may also be used.

In some implementations, the IoT module 610 may further include location and sensing components, such as a GPS receiver and one or more supplementary inertial measurement units, along with local storage for logs and diagnostic data, and may be configured to process camera data using onboard compute resources, including a graphics processing unit (GPU) or tensor processing unit (TPU), to perform computer vision tasks such as obstacle detection or path recognition. The IoT module 610 may also interface with an audio subsystem, including a digital-to-analog converter (DAC) amplifier and speakers, to generate audible alerts, and may include a backup power source configured to maintain communication and location reporting when a primary battery is unavailable. Additionally, the IoT module 610 may support real-time streaming and edge processing by encoding and transmitting camera feeds for teleoperation while performing local inference or filtering to selectively transmit relevant data or alert conditions to a backend system.

In the example of FIG. 6, one or more of the actuators 630 are used to drive a stabilizing arm assembly of a scooter. In response to receiving the command, the ECU 620 determines target positions for one or more of the actuators 630 of the stabilizing arm assembly and generates control signals to drive the one or more actuators 630 toward those positions. For example, in the maintain-upright state, the ECU 620 may determine target angles for the left and right stabilizing arms to keep the scooter substantially upright relative to gravity. In the retract-stabilizer state, the ECU 620 may determine positions that fold or retract the arm assembly. In some implementations, the ECU 620 may generate a control signal to energize and/or disengage a steering system assembly to toggle between electronic or manual control of the scooter. In some implementations, one or more of the actuators 630 part of a steering system assembly used to steer the scooter.

In FIG. 6, the sensing module 640 includes one or more encoders 642, one or more IMUs 644, and one or more current sensors 646. During movement, one or more sensors of the sensing module 640 may provide real-time feedback to the ECU 620. In the example, encoder(s) 642 are configured to measure position or motion of actuator(s) 630. IMU(s) 644 are configured to measure scooter orientation and dynamic motion. Current sensor(s) 646, and/or other load-sensing devices, are configured to detect actuator load and/or abnormal resistance. Using this feedback, the ECU 620 may compare commanded positions with actual positions, evaluate scooter attitude and motion, and update the actuator commands in a closed-loop manner until the desired state is achieved or a fault condition is detected.

While the system operates in a given state, the ECU 620 may continuously adjust the stabilizing arm assembly based on updated sensor data. Based on roll angle, pitch angle, angular velocity, angular acceleration, and/or other motion-related values, the ECU 620 may determine whether the arms should remain retracted, move to a partially deployed position, move to a fully deployed position, or retract once stabilization is no longer needed. Where the stabilizing arms include multiple actuators, the ECU 620 may command the arms symmetrically or independently to achieve the desired support geometry.

Arm position may be controlled as a function of IMU-derived orientation such that the stabilizing arm assembly may maintain the scooter substantially upright even when the riding surface is sloped, crowned, ramped, or otherwise uneven. In such conditions, the ECU 620 may position the left and right arms at different angles to compensate for ground inclination while keeping the scooter body near vertical relative to gravity.

Deployment and retraction may occur automatically in response to operating conditions. For example, the ECU 620 may deploy the stabilizing arm assembly when tilt, roll rate, angular acceleration, and/or a derived fall-likelihood value exceeds one or more thresholds. The ECU 620 may retract the assembly once the scooter returns to a stable condition, when docking is initiated, or in response to user or operator input. The control logic may include, for example, a lookup table, geometric model, proportional controller, proportional-integral-derivative (PID) controller, state-feedback controller, adaptive controller, or other logic configured to map sensed conditions to actuator setpoints.

Safety logic may also be integrated into the control architecture. If sensed actuator current exceeds a threshold, and/or encoder feedback indicates absent, insufficient, excessive, delayed, or otherwise unexpected motion, the ECU 620 may identify an obstruction, pinch event, ground strike, mechanical jam, overload condition, end-of-travel event, or actuator malfunction. In response, the ECU 620 may stop, reverse, slow, de-rate, or otherwise modify operation of actuator(s) 630, hold position, retract the arm assembly, or enter a fault state. The ECU 620 may also inhibit arm motion if data from IMU(s) 644 is unavailable, contradictory, noisy, or inconsistent with encoder-derived actuator motion.

The ECU 620 may further communicate status information back to the IoT module 610, which may relay the information to the cloud infrastructure 650. The reported status may indicate, for example, that the requested state has been achieved, that the scooter remains in transition, or that an error, obstruction, overload, or sensor inconsistency has occurred. In this manner, the cloud infrastructure 650 may remotely monitor command execution, verify scooter condition, and/or issue additional instructions when appropriate.

### 8. Hardware Overview

Embodiments of the above-described system may be implemented in a computing environment including a network, a server (e.g., a “backend” server) that facilitates functions of the system, and one or more client devices that execute an application, such as a user mobile application, that interacts with the backend server to enable one or more of the user experiences described herein. Other embodiments may include additional or different components.

The network enables communication among the entities connected to it through one or more local-area networks and/or wide-area networks. In one embodiment, the network includes the Internet and uses standard wired and/or wireless communications technologies and/or protocols or may use custom and/or dedicated data communications technologies instead of, or in addition to, the ones described above.

The backend server includes a computing device for facilitating various functions described herein. The backend server may host a website accessible by a browser executing on the clients, may host a database server hosting data accessible by the backend server or one or more applications executing on the clients and/or may include an application server hosting content accessible by one or more applications executing on the clients. The backend server may perform various backend processing to facilitate tasks such as obtaining information, presenting information to the user, and/or facilitating generation of content. The backend server may include an application programming interface (API) that enables it to interface with a client device, a third-party database, or another server, such as for storing, processing, and/or retrieving information such as described herein.

In one or more implementations, one or more user devices and/or client devices include a computing device that interfaces with the backend server to obtain input from users and to receive and display information received from the backend server. Such devices may include, for example, a mobile device, a tablet, a laptop computer, a desktop computer, or other computing device capable of communicating and displaying information. The client devices may execute a browser or an application that interacts with the backend server to facilitate the functions of the respective devices described herein.

Embodiments of the described computing environment and corresponding processes may be implemented by one or more computing systems. The one or more computing systems include at least one processor and a non-transitory computer-readable storage medium storing instructions executable by the at least one processor for carrying out the processes and functions described herein. The computing system may include distributed network-based computing systems in which functions described herein are not necessarily executed on a single physical device but may be distributed across multiple devices. For example, some implementations may utilize cloud processing and storage technologies, virtual machines, or other technologies.

Some aspects of the techniques described herein are implemented by one or more computing devices that may be hard-wired to perform the techniques, that may include digital electronic devices such as one or more application-specific integrated circuits (ASICs), field programmable gate arrays (FPGAs), or network processing units (NPUs) that are persistently programmed to perform the techniques, or that may include one or more general purpose hardware processors programmed to perform the techniques pursuant to program instructions in firmware, memory, other storage, or a combination. Such computing devices may also combine custom hard-wired logic, ASICs, FPGAs, or NPUs with custom programming to accomplish the techniques. In some implementations, the system may be coupled to one or more external computing devices that may provide various control or command functions, such as, for example, desktop computer systems, portable computer systems, handheld devices, networking devices, or any other device that incorporates hard-wired and/or program logic to implement the techniques.

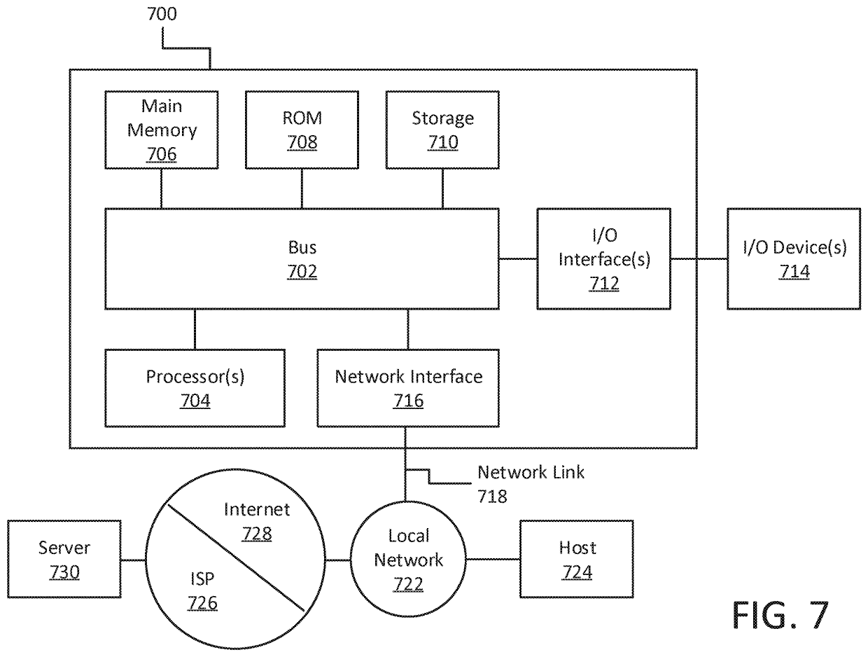

For example, FIG. 7 is a block diagram that illustrates a computer system 700 upon which one or more aspects of the disclosure may be implemented. For example, one or more client devices include one or more aspects of the example computer system 700. In FIG. 7, computer system 700 includes a bus 702 or other communication mechanism for communicating information, and a hardware processor 704 coupled with bus 702 for processing information. Hardware processor 704 may be, for example, a general-purpose microprocessor.

Computer system 700 also includes a main memory 706, such as a random-access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or a solid-state drive (SSD) is provided and coupled to bus 702 for storing information and instructions.

In one or more implementations, computer system 700 may be coupled via bus 702 to one or more input and/or output (I/O) device interfaces 712 that allow for the connection of various I/O devices 714 (e.g., keyboards, displays, mouse devices, pen input, etc.) to the computer system 700.

Computer system 700 may implement the techniques described herein using customized hard-wired logic, one or more ASICs or FPGAs, firmware, and/or program logic which in combination with the computer system causes or programs computer system 700 to be a special-purpose machine. According to one implementation, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative implementations, hard-wired circuitry may be used in place of or in combination with software instructions.

Storage media associated with the described system may include any non-transitory media that store data and/or instructions that cause a machine to operate in a specific fashion. Such storage media may include non-volatile media and/or volatile media. Non-volatile media includes, for example, optical or magnetic disks, such as storage device 710. Volatile media includes dynamic memory, such as main memory 706. Common forms of storage media include, for example, a hard disk, solid state drive, optical data storage medium, a random-access memory (RAM), a programmable read-only memory (PROM), and erasable programmable read-only memory (EPROM), a FLASH-EPROM, non-volatile random-access memory (NVRAM), any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire, and fiber optics, including the wires of bus 702. Transmission media can also take the form of acoustic or light waves, such as those generated during radio-wave and infrared data communications.

Various forms of media may be involved in carrying one or more sequences of one or more instructions to processor 704 for execution. For example, the instructions may initially be carried on a storage medium of a remote computer. The remote computer can load the instructions into its dynamic memory and send the instructions over a network. Bus 702 carries the data to main memory 706, from which processor 704 retrieves and executes the instructions. The instructions received by main memory 706 may optionally be stored on storage device 710 either before or after execution by processor 704.

In one or more implementations, computer system 700 also includes a network interface 716 coupled to bus 702. This may enable the described system to connect to an external local device (such as a mobile device or personal computer) and/or to one or more remote servers that may support various operations of the described system. Network interface 716 provides a two-way data communication coupling to a network link 718 that is connected to a local network 722. For example, network interface 716 may include a local area network (LAN) interface to provide a data communication connection to a compatible LAN. Wireless links may also be implemented. In implementations, network interface 716 sends and/or receives electrical, electromagnetic, and/or optical signals that carry digital data streams representing various types of information. In one or more implementations the network interface 716 may be used to load configuration parameters and/or to update firmware associated with one or more controllers or microcontrollers deployed by the system.

Network link 718 typically provides data communication through one or more networks to other data devices. For example, network link 718 may provide a connection through local network 722 to a host computer 724 or to data equipment operated by an Internet Service Provider (ISP) 726. ISP 726 in turn provides data communication services through the worldwide packet data communication network (e.g., the Internet) 728. Local network 722 and/or Internet 728 use electrical, electromagnetic, and/or optical signals that carry digital data streams. The signals through various networks and the signals on network link 718 and through network interface 716, which carry the digital data to and from computer system 700, are example forms of transmission media.

Computer system 700 can send messages and receive data, including program code, through the network(s), network link 718 and network interface 716. In the Internet example, a server 730 might transmit a requested code for an application program through Internet 728, ISP 726, local network 722 and network interface 716. The received code may be executed by processor 704 as it is received, and/or stored in storage device 710, or other non-volatile storage for later execution.

### 9. Miscellaneous; Extensions

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information, or as modules for executing these operations. Embodiments may also include methods in which steps may be performed in different order than in the example embodiments described and/or illustrated in the figures. Any of the methods described herein may be implemented as a computer program including instructions stored in a tangible non-transitory computer-readable storage medium. These instructions may be executed by one or more processors to carry out the functions described.

The language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Persons skilled in the relevant art can appreciate that many modifications and variations are possible considering the above disclosure. Accordingly, the disclosure of the embodiments is intended to be illustrative, but not limiting, of the scope of the patent rights, which is set forth in the following claims.

What is claimed is:

1. A self-stabilizing vehicle system, comprising:
a vehicle body;
a mobility arrangement configured to support movement of the vehicle body;
a stabilizing assembly coupled to the vehicle body, the stabilizing assembly comprising: (i) a first stabilizing arm arrangement disposed on a first lateral side of the vehicle body and (ii) a second stabilizing arm arrangement disposed on a second lateral side of the vehicle body opposite the first lateral side, wherein:
the first stabilizing arm arrangement includes (i) a first proximal arm portion and (ii) a first distal arm portion movable relative to the first proximal arm portion; and
the second stabilizing arm arrangement includes (i) a second proximal arm portion and (ii) a second distal arm portion movable relative to the second proximal arm portion;
a first actuator set comprising one or more actuators operatively coupled to the first stabilizing arm arrangement and configured to move the first stabilizing arm arrangement between a first retracted state and a first deployed state in which at least a first portion of the first stabilizing arm arrangement engages a ground surface;
a second actuator set comprising one or more actuators operatively coupled to the second stabilizing arm arrangement and configured to move the second stabilizing arm arrangement between a second retracted state and a second deployed state in which at least a second portion of the second stabilizing arm arrangement engages the ground surface; and
a control system (i) operatively coupled to at least one of the first actuator set or the second actuator set and (ii) configured to drive at least one of the first actuator set or the second actuator set, wherein
the vehicle is stabilized by at least one of: (i) the first portion engaging the ground surface while the first stabilizing arm arrangement is in the first deployed state or (ii) the second portion engaging the ground surface while the second stabilizing arm arrangement is in the second deployed state.

2. The system of claim 1, further comprising:
an inertial measurement unit configured to transmit orientation data indicative of an orientation of the vehicle body to the control system, wherein the control system is configured to: move the first stabilizing arm arrangement between the first retracted state and the first deployed state based on the orientation data; and
move the second stabilizing arm arrangement between the second retracted state and the second deployed state based on the orientation data.

3. The system of claim 2, wherein:
the control system is configured to, in response to the orientation data indicating a ground surface incline, asymmetrically deploy the first stabilizing arm arrangement and the second stabilizing arm arrangement, such that the first stabilizing arm arrangement and the second stabilizing arm arrangement extend by different amounts, to account for the ground surface incline.

4. The system of claim 2, wherein:
the control system is configured to, in response to orientation data indicating a leaning of the vehicle body that satisfies a threshold condition, at least partially deploy at least one of the first stabilizing arm arrangement or the second stabilizing arm arrangement to engage the ground surface prior to the vehicle body reaching a fully tipped state.

5. The system of claim 1, wherein:
the first actuator set comprises (i) a first proximal actuator operatively coupled to a mount and to the first proximal arm portion and (ii) a first distal actuator operatively coupled to the first proximal arm portion and the first distal arm portion; and
the second actuator set comprises (i) a second proximal actuator operatively coupled to the mount and to the second proximal arm portion and (ii) a second distal actuator operatively coupled to the second proximal arm portion and the second distal arm portion.

6. The system of claim 1, wherein:
the first proximal arm portion is movably coupled to the vehicle body via a mount;
the first distal arm portion is movably coupled to the first proximal arm portion;
the second proximal arm portion is movably coupled to the vehicle body via the mount; and
the second distal arm portion is movably coupled to the second proximal arm portion.

7. The system of claim 1, wherein:
the stabilizing assembly further comprises a first caster wheel, a second caster wheel, a first caster wheel mount, and a second caster wheel mount;
the first caster wheel mount is coupled to a distal end region of the first distal arm portion;
the first caster wheel is coupled to the first distal arm portion by the first caster wheel mount and is configured to pivot around a first vertical axis relative to the first distal arm portion;
the second caster wheel mount is coupled to a distal end region of the second distal arm portion; and
the second caster wheel is coupled to the second distal arm portion by the second caster wheel mount and is configured to pivot around a second vertical axis relative to the second distal arm portion.

8. The system of claim 1, wherein:
the stabilizing assembly further comprises a first proximal planetary gearbox, a first distal planetary gearbox, a second proximal planetary gearbox, and a second distal planetary gearbox;
the first proximal planetary gearbox is operatively coupled to the first actuator set to drive movement of the first proximal arm portion;
the first distal planetary gearbox is operatively coupled to the first actuator set to drive movement of the first distal arm portion;
the second proximal planetary gearbox is operatively coupled to the second actuator set to drive movement of the second proximal arm portion; and
the second distal planetary gearbox is operatively coupled to the second actuator set to drive movement of the second distal arm portion.

9. The system of claim 1, wherein:
the stabilizing assembly further comprises a first magnetic alignment structure configured to rotationally align a ground-engaging wheel of the first stabilizing arm arrangement during a transition to the first retracted state to facilitate receipt of the ground-engaging wheel within a lateral width of the vehicle body; and
the first magnetic alignment structure comprises:
a first magnet carried by the ground-engaging wheel or a wheel mount of the first stabilizing arm arrangement; and
a corresponding magnetic element disposed on a protective cover or an adjacent portion of the vehicle body and positioned to magnetically bias the ground-engaging wheel toward a predetermined rotational orientation during the transition to the first retracted state.

10. The system of claim 1, wherein:
the control system is configured to cause the vehicle body to move a distance forward, prior to a retraction of at least one of the first stabilizing arm arrangement or the second stabilizing arm arrangement, such that at least one ground-engaging wheel of the at least one of the first stabilizing arm arrangement or the second stabilizing arm arrangement rotates into an orientation facilitating the retraction.

11. The system of claim 1, further comprising:
a proximity sensor configured to detect a proximity of an object in a deployment path of at least one of the first stabilizing arm arrangement or the second stabilizing arm arrangement, wherein the control system is configured to inhibit or modify deployment of the at least one of the first stabilizing arm arrangement or the second stabilizing arm arrangement in response to the proximity sensor detecting the object in the deployment path.

12. The system of claim 1, wherein:
the vehicle body comprises a narrow profile;
the first stabilizing arm arrangement is located within a lateral width of the narrow profile when in the first retracted state; and
the second stabilizing arm arrangement is located within the lateral width when in the second retracted state.

13. The system of claim 1, wherein:
the control system is configured to control the first stabilizing arm arrangement independently of the second stabilizing arm arrangement such that: (i) the first stabilizing arm arrangement is movable to a first degree of deployment and (ii) the second stabilizing arm arrangement is movable to a second degree of deployment different from the first degree of deployment.

14. The system of claim 1, further comprising:
a current sensor configured to detect an electrical current associated with driving at least one actuator of the first actuator set or the second actuator set, wherein the control system is configured to, in response to the electrical current satisfying a threshold condition indicative of an obstruction, alter the driving of the at least one actuator.

15. A stabilizing assembly for a vehicle, comprising:
a mounting structure configured to couple to a vehicle body of the vehicle;
a first stabilizing arm arrangement configured to be disposed on a first lateral side of the vehicle body when the mounting structure is coupled to the vehicle body, wherein the first stabilizing arm arrangement includes (i) a first proximal arm portion and (ii) a first distal arm portion movable relative to the first proximal arm portion;
a second stabilizing arm arrangement configured to be disposed on a second lateral side of the vehicle body, opposite the first lateral side, when the mounting structure is coupled to the vehicle body, wherein the second stabilizing arm arrangement includes (i) a second proximal arm portion and (ii) a second distal arm portion movable relative to the second proximal arm portion;
a first actuator set comprising one or more actuators operatively coupled to the first stabilizing arm arrangement and configured to move the first stabilizing arm arrangement between a first retracted state and a first deployed state in which at least a first portion of the first stabilizing arm arrangement engages a ground surface;
a second actuator set comprising one or more actuators operatively coupled to the second stabilizing arm arrangement and configured to move the second stabilizing arm arrangement between a second retracted state and a second deployed state in which at least a second portion of the second stabilizing arm arrangement engages the ground surface; and
a control system (i) operatively coupled to the first actuator set and the second actuator set and (ii) configured to drive the first actuator set and the second actuator set, wherein
the vehicle is stabilized by at least one of: (i) the first portion engaging the ground surface while the first stabilizing arm arrangement is in the first deployed state or (ii) the second portion engaging the ground surface while the second stabilizing arm arrangement is in the second deployed state.

16. A method of stabilizing a vehicle using a stabilizing assembly, comprising:
detecting a deployment condition;
responsive to detecting the deployment condition, driving, by a control system, using at least one actuator, at least one of a first stabilizing arm arrangement of the stabilizing assembly or a second stabilizing arm arrangement of the stabilizing assembly from a retracted state toward a deployed state in which at least one of a first ground-engaging member or a second ground-engaging member engages a ground surface, wherein:
the first stabilizing arm arrangement is disposed on a first lateral side of the vehicle;
the second stabilizing arm arrangement is disposed on a second lateral side of the vehicle opposite the first lateral side;
the first stabilizing arm arrangement includes (i) a first proximal arm portion and (ii) a first distal arm portion movable relative to the first proximal arm portion;
the second stabilizing arm arrangement includes (i) a second proximal arm portion and (ii) a second distal arm portion movable relative to the second proximal arm portion;
the first ground-engaging member is coupled to a first distal end region of the first distal arm portion;
the second ground-engaging member is coupled to a second distal end region of the second distal arm portion; and
the control system is operatively coupled to and configured to drive the at least one actuator.

17. The method of claim 16, further comprising:
receiving, from an inertial measurement unit (IMU) associated with the vehicle, orientation data indicative of an orientation of the vehicle; and
responsive to the orientation data indicating a ground surface incline, asymmetrically deploying the first stabilizing arm arrangement and the second stabilizing arm arrangement such that the first stabilizing arm arrangement and the second stabilizing arm arrangement extend by different amounts to account for the ground surface incline.

18. The method of claim 16, further comprising:
receiving, from an inertial measurement unit (IMU) associated with the vehicle, orientation data indicative of an orientation of the vehicle; and
responsive to the orientation data indicating a leaning of the vehicle that satisfies a threshold condition, at least partially deploying at least one of the first stabilizing arm arrangement or the second stabilizing arm arrangement to engage the ground surface prior to the vehicle reaching a fully tipped state.

19. The method of claim 16, further comprising:
detecting, with a current sensor, an electrical current associated with driving at least one actuator used to move at least one of the first stabilizing arm arrangement or the second stabilizing arm arrangement; and
responsive to the electrical current satisfying a threshold condition indicative of an obstruction, altering the driving of the at least one actuator.

20. The method of claim 16, further comprising:
detecting a retraction condition;
aligning at least one of the first ground-engaging member or the second ground-engaging member; and
retracting at least one of the first stabilizing arm arrangement or the second stabilizing arm arrangement.
